(19) United States
(12) Patent Application Publication
(10) Pub. No.: US 2026/0043987 A1
(43) Pub. Date: Feb. 12, 2026

(54) CAMERA MODULE AND ELECTRONIC DEVICE INCLUDING THE SAME

(71) Applicant: SAMSUNG ELECTRONICS CO., LTD., Suwon-si (KR)

(72) Inventors: Hwanseon LEE, Suwon-si (KR); Jeongkil Shin, Suwon-si (KR)

(73) Assignee: SAMSUNG ELECTRONICS CO., LTD., Suwon-si (KR)

(21) Appl. No.: 19/217,359

(22) Filed: May 23, 2025

Related U.S. Application Data
(63) Continuation of application No. PCT/KR2025/006604, filed on May 15, 2025.

(30) Foreign Application Priority Data
Aug. 8, 2024 (KR) 10-2024-0106016
Sep. 11, 2024 (KR) 10-2024-0123747

(51) Int. Cl. G02B 9/64; G02B 13/18

(52) U.S. Cl. CPC G02B 9/64; G02B 13/18

(57) ABSTRACT

A camera module includes: an image sensor; and a lens assembly including at least seven lenses aligned along an optical axis and configured to guide light from outside the camera module to the image sensor, where the at least seven lenses include: a first lens farthest from the image sensor and including a convex surface on a sensor-side surface thereof, the first lens having negative refractive power; a second lens between the first lens and the image sensor, and having positive refractive power; a third lens between the second lens and the image sensor, and having positive refractive power; a fourth lens between the third lens and the image sensor, and having positive refractive power or negative refractive power; a fifth lens between the fourth lens and the image sensor, and having negative refractive power.

### CROSS-REFERENCE TO RELATED APPLICATION(S)

This application is a continuation application, claiming priority under § 365 (c), of an International application No. PCT/KR2025/006604, filed on May 15, 2025, which is based on and claims the benefit of a Korean patent application number 10-2024-0106016, filed on Aug. 8, 2024, in the Korean Intellectual Property Office, and of a Korean patent application number 10-2024-0123747, filed on Sep. 11, 2024, in the Korean Intellectual Property Office, the disclosure of each of which is incorporated by reference herein in its entirety.

### BACKGROUND

### 1. Field

The disclosure relates to an electronic device, for example, a camera module and/or an electronic device including the same.

### 2. Description of Related Art

An electronic device may refer to a device that performs a specified function according to a loaded program, such as a home appliance, an electronic notebook, a portable multimedia player, a mobile communication terminal, a tablet PC, an audio/video device, a desktop/laptop computer, and/or a vehicle navigation device. For example, these electronic devices may output stored information as sound or an image. As the integration level of electronic devices increases and ultra-high-speed, high-capacity wireless communications become widespread, various functions may be installed in a single electronic device such as a mobile communication terminal. For example, in addition to a communication function, an entertainment function such as games, a multimedia function such as music/video playback, a communication and security function for mobile banking, and/or schedule management or an electronic wallet function is integrated into a single electronic device.

Along with the development of the manufacturing technology of digital cameras, electronic devices equipped with small, lightweight camera modules have become commercialized. As a camera module is installed in an electronic device (e.g. a mobile communication terminal) that is usually carried around, a user may conveniently use various functions such as taking pictures or videos, video calls, and/or augmented reality.

The above information is presented as related art only to assist with an understanding of the disclosure.

### SUMMARY

Aspects will be set forth in part in the description which follows and, in part, will be apparent from the description, or may be learned by practice of the presented embodiments.

According to an aspect of the disclosure, a camera module may include: an image sensor; and a lens assembly including at least seven lenses aligned along an optical axis and configured to guide light from outside the camera module to the image sensor, where the at least seven lenses include: a first lens farthest from the image sensor and including a convex surface on a sensor-side surface thereof, the first lens having negative refractive power; a second lens between the first lens and the image sensor, and having positive refractive power; a third lens between the second lens and the image sensor, and having positive refractive power; a fourth lens between the third lens and the image sensor, and having positive refractive power or negative refractive power; a fifth lens between the fourth lens and the image sensor, and having negative refractive power; a sixth lens between the fifth lens and the image sensor and including a concave surface on an object-side surface thereof, the sixth lens having positive refractive power; and a seventh lens between the sixth lens and the image sensor, and having negative refractive power, where the lens assembly satisfies: f/f6≤1, and where f is a focal length of the lens assembly, and f6 is a focal length of the sixth lens.

The lens assembly may further satisfy: 25≤vd2≤45, where vd2 is an Abbe number of the second lens.

The lens assembly may further satisfy: −3≤(r1+r2)/(r1−r2)≤−1.05, where r1 is a radius of curvature of an object-side surface of the first lens, and r2 is a radius of curvature of the sensor-side surface of the first lens.

The fifth lens may include a concave surface on a sensor-side surface thereof.

The third lens may include a convex surface on an object-side surface thereof.

A refractive index of at least one of the first lens, the third lens, the fourth lens, or the sixth lens may be 1.53 or more and 1.55 or less.

An Abbe number of at least one of the first lens, the third lens, the fourth lens, or the sixth lens may be 50 or more and 60 or less.

A refractive index of at least one of the second lens, the fifth lens, or the seventh lens may be 1.56 or more and 1.68 or less.

An Abbe number of at least one of the fifth lens or the seventh lens may be 18 or more and 40 or less.

A refractive index of the first lens, a refractive index of the third lens, a refractive index of the fourth lens, and a refractive index of the sixth lens may be 1.53 or more and 1.55 or less, where an Abbe number of the first lens, an Abbe number of the third lens, an Abbe number of the fourth lens, and an Abbe number of the sixth lens are 50 or more and 60 or less, where a refractive index of the second lens, a refractive index of the fifth lens, and a refractive index of the seventh lens are 1.56 or more and 1.68 or less, and where an Abbe number of the fifth lens and an Abbe number of the seventh lens are 18 or more and 40 or less.

According to an aspect of the disclosure, an electronic device may include: a camera module; at least one processor; and memory storing instructions which, when executed by the at least one processor, cause the electronic device to obtain an image using the camera module, where the camera module includes: an image sensor; and a lens assembly including at least seven lenses aligned along an optical axis and configured to guide light from outside the camera module to the image sensor, where the at least seven lenses include: a first lens farthest from the image sensor and including a convex surface on a sensor-side surface thereof, the first lens having negative refractive power; a second lens between the first lens and the image sensor and having positive refractive power; a third lens between the second lens and the image sensor, and having positive refractive power; a fourth lens between the third lens and the image sensor, and having positive refractive power or negative refractive power; a fifth lens between the fourth lens and the image sensor, and having negative refractive power; a sixth lens between the fifth lens and the image sensor and including a concave surface on an object-side surface thereof, the sixth lens having positive refractive power; and a seventh lens between the sixth lens and the image sensor, and having negative refractive power, where the lens assembly satisfies: f/f6≤1, wherein f is a focal length of the lens assembly, and f6 is a focal length of the sixth lens.

The instructions, when executed by the at least one processor, may further cause the electronic device to perform a focus adjustment operation by moving at least one of the at least seven lenses in a direction of the optical axis.

The instructions, when executed by the at least one processor, may further cause the electronic device to perform a hand tremor correction operation by moving at least one of the at least seven lenses in a direction parallel to a plane perpendicular to the optical axis.

The lens assembly may further satisfy: 25≤vd2≤45, where vd2 is an Abbe number of the second lens.

The lens assembly may further satisfy: −3≤(r1+r2)/(r1−r2)≤−1.05, where r1 is a radius of curvature of an object-side surface of the first lens, and r2 is a radius of curvature of the sensor-side surface of the first lens.

The fifth lens may include a concave surface on a sensor-side surface thereof.

A refractive index of at least one of the first lens, the third lens, the fourth lens, or the sixth lens may be 1.53 or more and 1.55 or less.

An Abbe number of at least one of the first lens, the third lens, the fourth lens, or the sixth lens may be 50 or more and 60 or less.

A refractive index of at least one of the second lens, the fifth lens, or the seventh lens may be 1.56 or more and 1.68 or less.

An Abbe number of at least one of the fifth lens or the seventh lens may be 18 or more and 40 or less.

According to an aspect of the disclosure, a camera module may include: an image sensor; and a lens assembly including at least seven lenses aligned along an optical axis and configured to guide light from outside the camera module to the image sensor, where the at least seven lenses include: a first lens farthest from the image sensor and including a convex surface on a sensor-side surface thereof, the first lens having negative refractive power; a second lens between the first lens and the image sensor, and having positive refractive power; a third lens between the second lens and the image sensor, and having positive refractive power; a fourth lens between the third lens and the image sensor, and having positive refractive power or negative refractive power; a fifth lens between the fourth lens and the image sensor, and having negative refractive power; a sixth lens between the fifth lens and the image sensor and comprising a concave surface on an object-side surface thereof, the sixth lens having positive refractive power; and a seventh lens between the sixth lens and the image sensor, and having negative refractive power, and where the lens assembly satisfies at least one of: f/f6≤1, where f is a focal length of the lens assembly, and f6 is a focal length of the sixth lens, 25≤vd2≤45, where vd2 is an Abbe number of the second lens, or −3≤(r1+r2)/(r1−r2)≤−1.05, where r1 is a radius of curvature of an object-side surface of the first lens, and r2 is a radius of curvature of the sensor-side surface of the first lens.

A refractive index of at least one of the first lens, the third lens, the fourth lens, and the sixth lens may be less than a refractive index of the second lens, a refractive index of the fifth lens, and a refractive index of the seventh lens.

An Abbe number of at least one of the first lens, the third lens, the fourth lens, and the sixth lens may be greater than the Abbe number of the second lens, an Abbe number of the fifth lens, and an Abbe number of the seventh lens.

A refractive index of at least one of the second lens, the fifth lens, and the seventh lens may be greater than a refractive index of the first lens, a refractive index of the third lens, a refractive index of the fourth lens, and a refractive index of the sixth lens.

An Abbe number of at least one of the fifth lens and the seventh lens may be less than an Abbe number of the first lens, an Abbe number of the third lens, an Abbe number of the fourth lens, and an Abbe number of the sixth lens.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to an embodiment of the disclosure;

FIG. 2 is a front perspective view illustrating an electronic device according to an embodiment of the disclosure;

FIG. 3 is a rear perspective view illustrating an electronic device according to an embodiment of the disclosure;

FIG. 4 is an exploded perspective view illustrating the front surface of the electronic device illustrated in FIG. 2 according to an embodiment of the disclosure;

FIG. 5 is an exploded perspective view illustrating the rear surface of the electronic device illustrated in FIG. 2 according to an embodiment of the disclosure;

FIG. 6 is a diagram illustrating a camera module and/or a lens assembly according to an embodiment of the disclosure;

FIG. 7 is a graph illustrating spherical aberration of the lens assembly of FIG. 6 according to an embodiment of the disclosure;

FIG. 8 is a graph illustrating astigmatism of the lens assembly of FIG. 6 according to an embodiment of the disclosure;

FIG. 9 is a graph illustrating distortion of the lens assembly of FIG. 6 according to an embodiment of the disclosure;

FIG. 10 is a diagram illustrating a camera module and/or a lens assembly according to an embodiment of the disclosure;

FIG. 11 is a graph illustrating spherical aberration of the lens assembly of FIG. 10 according to an embodiment of the disclosure;

FIG. 12 is a graph illustrating astigmatism of the lens assembly of FIG. 10 according to an embodiment of the disclosure;

FIG. 13 is a graph illustrating distortion of the lens assembly of FIG. 10 according to an embodiment of the disclosure;

FIG. 14 is a diagram illustrating a camera module and/or a lens assembly according to an embodiment of the disclosure;

FIG. 15 is a graph illustrating spherical aberration of the lens assembly of FIG. 14 according to an embodiment of the disclosure;

FIG. 16 is a graph illustrating astigmatism of the lens assembly of FIG. 14 according to an embodiment of the disclosure;

FIG. 17 is a graph illustrating distortion of the lens assembly of FIG. 14 according to an embodiment of the disclosure;

FIG. 18 is a diagram illustrating a camera module and/or a lens assembly according to an embodiment of the disclosure;

FIG. 19 is a graph illustrating spherical aberration of the lens assembly of FIG. 18 according to an embodiment of the disclosure;

FIG. 20 is a graph illustrating astigmatism of the lens assembly of FIG. 18 according to an embodiment of the disclosure;

FIG. 21 is a graph illustrating distortion of the lens assembly of FIG. 18 according to an embodiment of the disclosure;

FIG. 22 is a diagram illustrating a camera module and/or a lens assembly according to an embodiment of the disclosure;

FIG. 23 is a graph illustrating spherical aberration of the lens assembly of FIG. 22 according to an embodiment of the disclosure;

FIG. 24 is a graph illustrating astigmatism of the lens assembly of FIG. 22 according to an embodiment of the disclosure;

FIG. 25 is a graph illustrating distortion of the lens assembly of FIG. 22 according to an embodiment of the disclosure;

FIG. 26 is a diagram illustrating a camera module and/or a lens assembly according to an embodiment of the disclosure;

FIG. 27 is a graph illustrating spherical aberration of the lens assembly of FIG. 26 according to an embodiment of the disclosure;

FIG. 28 is a graph illustrating astigmatism of the lens assembly of FIG. 26 according to an embodiment of the disclosure;

FIG. 29 is a graph illustrating distortion of the lens assembly of FIG. 26 according to an embodiment of the disclosure;

FIG. 30 is a diagram illustrating a camera module and/or a lens assembly according to an embodiment of the disclosure;

FIG. 31 is a graph illustrating spherical aberration of the lens assembly of FIG. 30 according to an embodiment of the disclosure;

FIG. 32 is a graph illustrating astigmatism of the lens assembly of FIG. 30 according to an embodiment of the disclosure; and

FIG. 33 is a graph illustrating distortion of the lens assembly of FIG. 30 according to an embodiment of the disclosure.

Throughout the accompanying drawings, like reference numerals may be assigned to like parts, components, and/or structures.

### MODE FOR THE INVENTION

As electronic devices become increasingly smaller, a condition for securing the optical performance of a camera module in a miniaturized electronic device becomes increasingly worse. For example, as the number and sizes of lenses increase, it may be easier to improve the optical performance of a camera module. However, when the lenses are mounted on a miniaturized electronic device, the number and sizes of lenses may be limited. On the other hand, when more pixels (e.g., approximately 50 million pixels or more) are arranged in an image sensor of the same size, the resolution of the image sensor may increase, but it may be difficult to secure the resolution of a lens assembly corresponding to it. For example, when the resolution of the image sensor increases, the optical performance of the camera module may be improved. However, when the camera module is mounted on the miniaturized electronic device, it may be difficult to implement a lens assembly corresponding to the resolution of the image sensor.

An embodiment of the disclosure is intended to at least solve the above problems and/or disadvantages and at least provide the advantages described below, and may provide a camera module having optical performance suitable for a high-performance and/or high-pixel image sensor, and/or an electronic device including the same.

An embodiment of the disclosure may provide a miniaturized camera module having improved optical performance (e.g., resolution) and/or an electronic device including the same.

The technical problems to be solved in the disclosure are not limited to those mentioned above, and other technical problems not mentioned may be clearly understood by those skilled in the art from the following description.

The following description of the attached drawings may provide an understanding of various exemplary implementations of the disclosure including the claims and their corresponding contents. An exemplary embodiment disclosed in the following description includes various specific details to help understanding, but is considered as one of various exemplary embodiments. Accordingly, those skilled in the art will understand that various changes and modifications may be made to the various implementations described in the disclosure without departing from the scope and spirit of the disclosure. In addition, a description of well-known functions and configurations may be omitted for clarity and conciseness.

The terms and words used in the following description and claims are not limited to their referential meanings, but may be used to clearly and consistently describe embodiments of the disclosure. Accordingly, it will be apparent to those skilled in the art that the following description of various implementations of the disclosure is provided for purposes of illustration and not for the purpose of limiting the scope of the disclosure, which is intended to be in accordance with the claims.

Unless the context clearly indicates otherwise, it should be understood that the singular forms of “a,” “an,” and “the” include plural meanings. Thus, for example, a “component surface” may be understood to include one or more of the surfaces of a component.

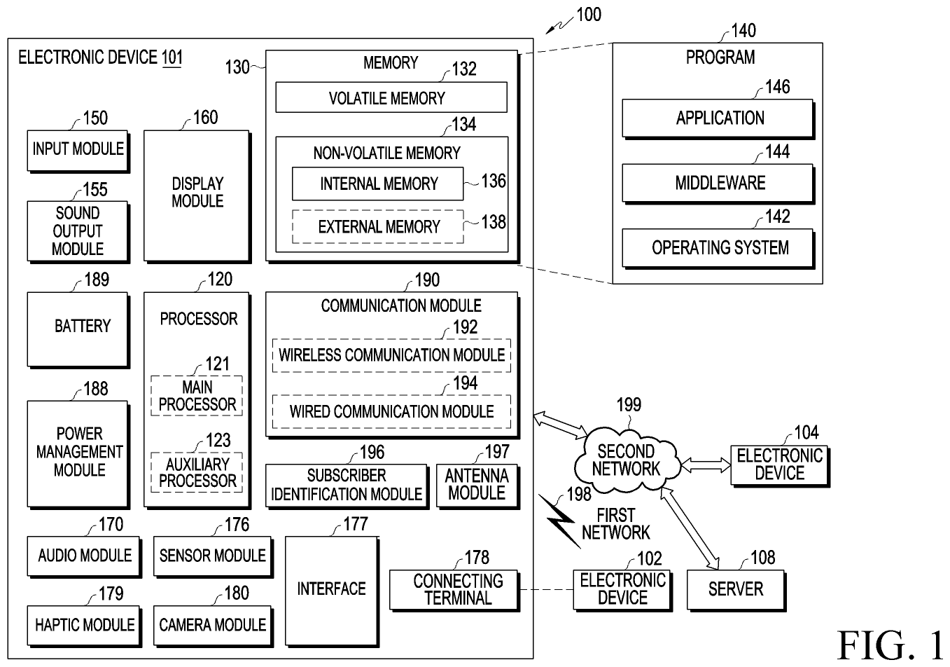

FIG. 1 is a block diagram illustrating an electronic device 101 in a network environment 100 according to an embodiment of the disclosure. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134 (e.g., internal memory 136 or external memory 138). According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to embodiment(s) of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., a program) including one or more instructions that are stored in a storage medium (e.g., internal memory or external memory) that is readable by a machine (e.g., an electronic device). For example, a processor (e.g., a processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiment(s) of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

In the following detailed description, a longitudinal direction, width direction, and/or thickness direction of the electronic device may be mentioned. The longitudinal direction may be defined as a ‘Y-axis direction’, the width direction as an ‘X-axis direction’, and/or the thickness direction as a ‘Z-axis direction’. In an embodiment, regarding directions in which components are oriented, ‘negative/positive (−/+)’ may be mentioned together with the Cartesian coordinate system illustrated in the drawings. For example, the front surface of the electronic device and/or a housing may be defined as a ‘surface facing a +Z direction’, and the rear surface thereof may be defined as a ‘surface facing a −Z direction’. In an embodiment, a side surface of the electronic device and/or the housing may include an area facing a +X direction, an area facing a +Y direction, an area facing a −X direction, and/or an area facing a −Y direction. In an embodiment, the ‘X-axis direction’ may mean both the ‘−X direction’ and the ‘+X direction’. It should be noted that this is based on the Cartesian coordinate system illustrated in the drawings, for brevity of description, and that the description of these directions or components does not limit the embodiment(s) of the disclosure. For example, depending on the design specifications of the electronic device or the usage habits of a user, the Cartesian coordinate system may be defined differently from that of the disclosure.

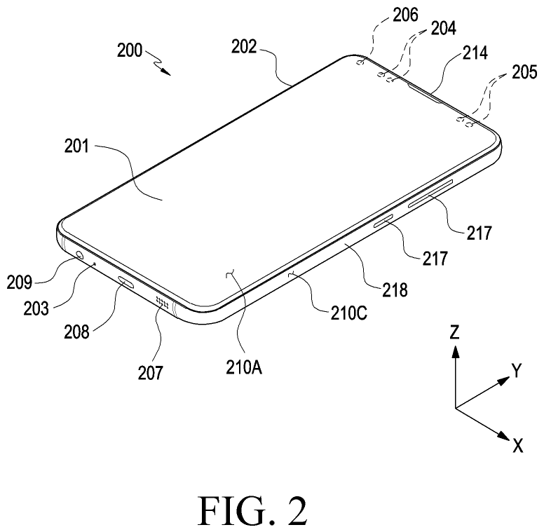

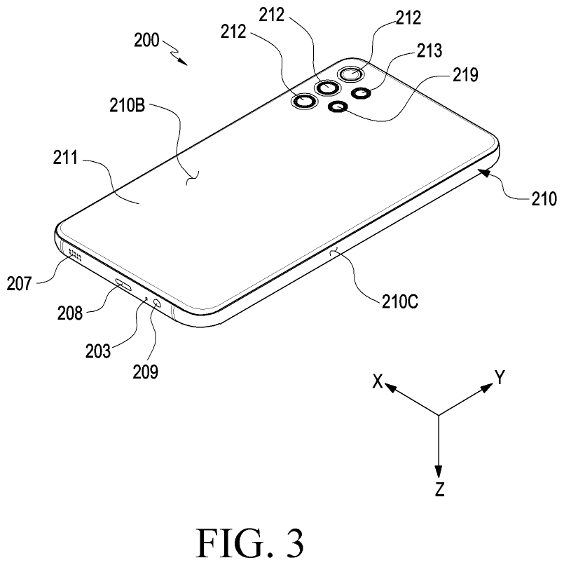

FIG. 2 is a front perspective view illustrating an electronic device 200 (e.g., the electronic device 101 of FIG. 1) according to an embodiment of the disclosure. FIG. 3 is a rear perspective view illustrating the electronic device 200 illustrated in FIG. 2 according to an embodiment of the disclosure.

Referring to FIGS. 2 and 3, the electronic device 200 (e.g., the electronic device 101 in FIG. 1) according to an embodiment may include a housing 210 which includes a first surface (or front surface) 210A, a second surface (or rear surface) 210B, and a side surface 210C surrounding a space between the first surface 210A and the second surface 210B. In an embodiment, the housing 210 may refer to a structure that forms a portion of the first surface 210A, the second surface 210B, and the side surfaces 210C of FIG. 2. According to an embodiment, at least a portion of the first surface 210A may be formed by a front plate 202 (e.g., a glass plate or polymer plate including various coating layers) which is at least partially substantially transparent. The second surface 210B may be formed by a rear plate 211 which is substantially opaque. The rear plate 211 may be formed of, for example, coated or tinted glass, ceramic, a polymer, a metal (e.g., aluminum, stainless steel (STS), or magnesium), or a combination of at least two of these materials. The side surface 210C may be coupled to the front plate 202 and the rear plate 211 and formed by a side structure (or “side bezel structure”) 218 including a metal and/or a polymer. In an embodiment, the rear plate 211 and the side structure 218 may be integrally formed and include the same material (e.g., a metal material such as aluminum).

The front plate 202 may include extended area(s) which are bent and extend seamlessly from at least a portion of an edge toward the rear plate 211. In an embodiment, the front plate 202 (or the rear plate 211) may include only one of the areas bent and extended toward the rear plate 211 (or the front plate 202) at one edge of the first surface 210A. According to an embodiment, the front plate 202 or the rear plate 211 may have a substantially flat shape, and in this case, may not include any bent and extended area. When a bent and extended area is included, the electronic device 200 may have a smaller thickness in a portion including the bent and extended area than in the other portions.

According to an embodiment, the electronic device 200 may include at least one of a display 201, audio modules 203, 207, and 214, sensor modules 204 and 219, camera modules 205, 212, and 213, key input devices 217, a light emitting element 206, or connector holes 208 and 209. In an embodiment, the electronic device 101 may not be provided with at least one (e.g., a key input device 217 or the light emitting element 206) of the components or may additionally include other components.

The display 201 may be visually exposed, for example, through a substantial portion of the front plate 202. In an embodiment, at least a portion of the display 201 may be exposed through the front plate 202 forming the first surface 210A or a portion of the side surface 210C. In an embodiment, a corner of the display 201 may be formed substantially in the same shape as that of an adjacent periphery of the front plate 202. In an embodiment, a gap between the periphery of the display 201 and the periphery of the front plate 202 may be substantially equal to increase the visually exposed area of the display 201.

In an embodiment, a recess or an opening may be formed in a portion of a screen display area, and at least one of the audio module 214, the sensor module 204, the camera module 205, or the light emitting element 206, which is aligned with the recess or the opening, may be included. In an embodiment, at least one of the audio module 214, the sensor module 204, the camera modules 205, a fingerprint sensor, or the light emitting element 206 may be included on the rear surface of the screen display area of the display 201. In an embodiment, the display 201 may be incorporated with or disposed adjacent to a touch sensing circuit, a pressure sensor capable of measuring the intensity (pressure) of a touch, and/or a digitizer that detects a magnetic field-based stylus pen. In an embodiment, at least some of the sensor modules 204 and 219 and/or at least some of the key input devices 217 may be disposed in areas (or spaces) overlapping the display 201.

According to an embodiment, the audio modules 203, 207, and 214 may include a microphone hole 203 and speaker holes 207 and 214. A microphone for obtaining an external sound may be disposed in the microphone hole 203, and in an embodiment, a plurality of microphones may be disposed to detect the direction of a sound. The speaker holes 207 and 214 may include an external speaker hole 207 and a receiver hole 214 for calls. In an embodiment, the speaker holes 207 and 214 and the microphone hole 203 may be implemented as a single hole, or a speaker (e.g., a piezo speaker) may be included without the speaker holes 207 and 214.

According to an embodiment, the sensor modules 204 and 219 may generate an electrical signal or data value corresponding to an internal operating state or an external environmental state of the electronic device 200. The sensor modules 204 and 219 may include, for example, a first sensor module 204 (e.g., a proximity sensor) and/or a second sensor module (e.g., a fingerprint sensor), disposed on the first surface 210A of the housing 210, and/or a third sensor module 219 and/or a fourth sensor module (e.g., a fingerprint sensor), disposed on the second surface 210B of the housing 210. The fingerprint sensors may be disposed on the second surface 210B or the side surface 210C as well as on the first surface 210A (e.g., the display 201) of the housing 210. The electronic device 200 may further include a sensor module, for example, at least one of a gesture sensor, a gyro sensor, a barometric pressure sensor, a magnetic sensor, an acceleration sensor, a grip sensor, a color sensor, an IR sensor, a biometric sensor, a temperature sensor, a humidity sensor, or an illuminance sensor.

According to an embodiment, the camera modules 205, 212, and 213 may include a first camera module 205 disposed on the first surface 210A of the electronic device 200, and a second camera module 212 and/or a flash 213 disposed on the second surface 210B. The camera modules 205 and 212 may include one or more lenses, an image sensor, and/or an ISP. In an embodiment, the ISP may be implemented as a portion of the processor 120 of FIG. 1. In an embodiment, the ISP may be implemented in a component disposed separately from the processor 120 of FIG. 1. For example, the electronic device 200 may include at least one processor, and when the electronic device 200 includes a plurality of processors, the ISP may be mounted in a separate component from the other processors. The flash 213 may include, for example, a light emitting diode (LED) or a xenon lamp. In an embodiment, two or more lenses (an IR camera, a wide-angle lens, and a telephoto lens) and image sensors may be arranged on one surface of the electronic device 200. In an embodiment, the flash 213 may emit IR light, and IR light emitted by the flash 213 and reflected from an object may be received through the third sensor module 219. The electronic device 200 or the processor of the electronic device 200 may detect depth information of the object based on a time at which the IR light is received by the third sensor module 219.

According to an embodiment, the key input devices 217 may be disposed on the side surface 210C of the housing 210. In an embodiment, the electronic device 200 may not include some or any of the key input devices 217, and the key input devices 217 which are not included may be implemented in other forms such as soft keys on the display 201. In an embodiment, the key input devices may include a sensor module 316 disposed on the second surface 210B of the housing 210.

According to an embodiment, the light emitting element 206 may be disposed, for example, on the first surface 210A of the housing 210. The light emitting element 206 may provide, for example, state information about the electronic device 200 in the form of light. In an embodiment, the light emitting element 206 may provide, for example, a light source interworking with an operation of the camera module 205. The light emitting element 206 may include, for example, an LED, an IR LED, and a xenon lamp.

According to an embodiment, the connector holes 208 and 209 may include a first connector hole 208 capable of accommodating a connector (e.g., a USB connector) for transmitting and receiving power and/or data to and from an external electronic device and/or a second connector hole (e.g., an earphone jack) 209 capable of accommodating a connector for transmitting and receiving an audio signal to and from an external electronic device.

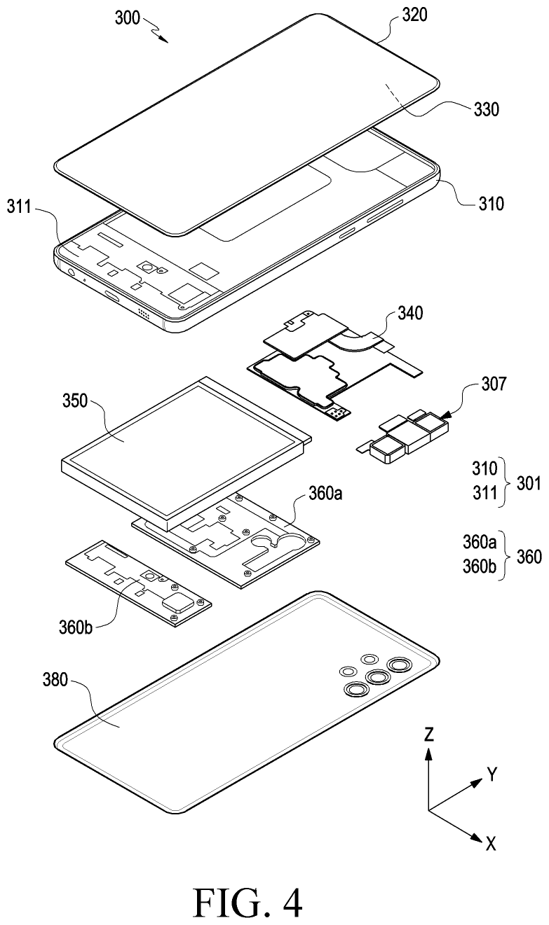

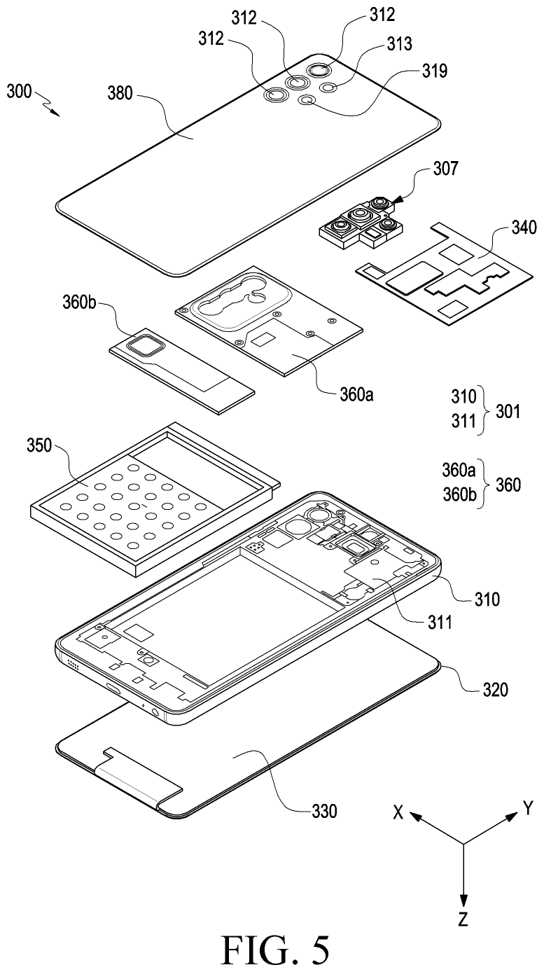

FIG. 4 is an exploded perspective view illustrating the front surface of the electronic device 200 illustrated in FIG. 2 according to an embodiment of the disclosure. FIG. 5 is an exploded perspective view illustrating the rear surface of the electronic device 200 illustrated in FIG. 2 according to an embodiment of the disclosure.

Referring to FIGS. 4 and 5, an electronic device 300 (e.g., the electronic device 200 of FIG. 2 or 3) may include a side structure 310, a first support member 311 (e.g., a bracket), a front plate 320 (e.g., the front plate 202 of FIG. 2), a display 330 (e.g., the display 201 of FIG. 2), a printed circuit board (or a board assembly) 340, a battery 350, a second support member 360 (e.g., a rear case), an antenna, a camera assembly 307, and a rear plate 380 (e.g., the rear plate 211 of FIG. 3). In an embodiment, the electronic device 300 may not be provided with at least one (e.g., the first support member 311 or the second support member 360) of the components or may additionally include other components. At least one of the components of the electronic device 300 may be identical or similar to at least one of the components of the electronic device 200 in FIG. 2 or FIG. 3, and any redundant description will be omitted below.

According to an embodiment, the first support member 311 may be provided at least partially in a flat shape. In an embodiment, the first support member 311 may be disposed inside the electronic device 300 and connected to the side structure 310, or may be formed integrally with the side structure 310. The first support member 311 may be formed of, for example, a metal material and/or a non-metallic (e.g., polymer) material together with the side structure 310. When formed at least partially of a metal material, the side structure 310 or a portion of the first support member 311 may function as an antenna. The first support member 311 may have one surface coupled to a display 330 and the other surface coupled to the printed circuit board 340. A processor, memory, and/or an interface may be mounted on the printed circuit board 340. The processor may include, for example, one or more of a central processing unit, an application processor, a graphics processing unit, an image signal processor, a sensor hub processor, or a communication processor.

In an embodiment, the first support member 311 and the side structure 310 may be combined to be referred to as a front case or a housing 301. In an embodiment, the housing 301 may be generally understood as a structure for receiving, protecting, or disposing the printed circuit board 340 or the battery 350. In an embodiment, the housing 301 may be understood as including a structure that may be visually or tactilely recognized by a user on the exterior of the electronic device 300, for example, the side structure 310, the front plate 320, and/or the rear plate 380. In an embodiment, the ‘front or rear surface of the housing 301’ may refer to the first surface 210A of FIG. 2 or the second surface 210B of FIG. 3. In an embodiment, the first support member 311 may be located between the front plate 320 (e.g., the first surface 210A of FIG. 2) and the rear plate 380 (e.g., the second surface 210B of FIG. 3) and function as a structure on which electrical/electronic components such as the printed circuit board 340 or the camera assembly 307 are disposed.

The memory may include, for example, volatile memory or nonvolatile memory.

The interface may include, for example, a high definition multimedia interface (HDMI), a universal serial bus (USB) interface, an SD card interface, and/or an audio interface. The interface may, for example, electrically or physically connect the electronic device 300 to an external electronic device, and may include a USB connector, an SD card/MMC connector, or an audio connector.

According to an embodiment, the second support member 360 may include, for example, an upper support member 360a and a lower support member 360b. In an embodiment, the upper support member 360a may be disposed to surround the printed circuit board 340, together with a portion of the first support member 311. A circuit device (e.g., a processor, a communication module, or memory) implemented in the form of an integrated circuit chip or various electrical/electronic components may be disposed on the printed circuit board 340, and according to an embodiment, the printed circuit board 340 may be provided with an electromagnetic shielding environment from the upper support member 360a. In an embodiment, the lower support member 360b may be used as a structure on which electrical/electronic components such as a speaker module and an interface (e.g., a USB connector, an SD card/MMC connector, or an audio connector) may be disposed. In an embodiment, electrical/electronic components such as a speaker module and an interface (e.g., a USB connector, an SD card/MMC connector, or an audio connector) may be disposed on an additional printed circuit board. In this case, the lower support member 360b may be disposed to surround the additional printed circuit board, together with another portion of the first support member 311. The speaker module or interface disposed on the additional printed circuit board or the lower support member 360b may be disposed to correspond to the audio module 207 or the connector hole 208 and 209 of FIG. 2.

According to an embodiment, the battery 350, which is a device for supplying power to at least one component of the electronic device 300, may include, for example, a non-rechargeable primary battery, a rechargeable secondary battery, or a fuel cell. At least a portion of the battery 350 may be disposed substantially on the same plane as, for example, the printed circuit board 340. The battery 350 may be integrally disposed within the electronic device 300, and may also be detachably disposed in the electronic device 300.

The antenna may include a conductive pattern implemented on the surface of the second support member 360, for example, by laser direct structuring. In an embodiment, the antenna may include a printed circuit pattern formed on the surface of a thin film, and the thin film-shaped antenna may be disposed between the rear plate 380 and the battery 350. The antenna may include, for example, a near field communication (NFC) antenna, a wireless charging antenna, and/or a magnetic secure transmission (MST) antenna. The antenna may, for example, perform short-range communication with an external device or wirelessly transmit and receive power required for charging. In an embodiment, another antenna structure may be formed by a portion or combination of the side structure 310 and/or the first support member 311.

According to an embodiment, the camera assembly 307 may include at least one camera module, for example, at least one of the camera modules 212 and 213 of FIG. 3. Inside the electronic device 300, the camera assembly 307 may receive at least a portion of light incident through an optical hole or camera windows 312, 313, and 319. In an embodiment, the camera assembly 307 may be disposed on the first support member 311 at a location adjacent to the printed circuit board 340. In an embodiment, the camera modules of the camera assembly 307 may be generally aligned with one of the camera windows 312, 313, and 319 and at least partially surrounded by the second support member 360 (e.g., the upper support member 360a). In disposing the camera assembly 307 or the camera modules 212 and 213 of FIG. 3, the electronic device 300 or the first support member 311 may include at least one structure, such as a support wall or an elastic member, to mount or secure the camera assembly 307.

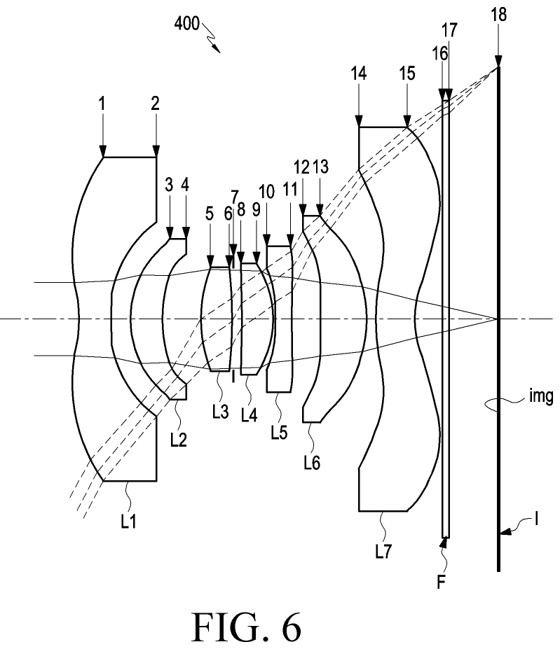

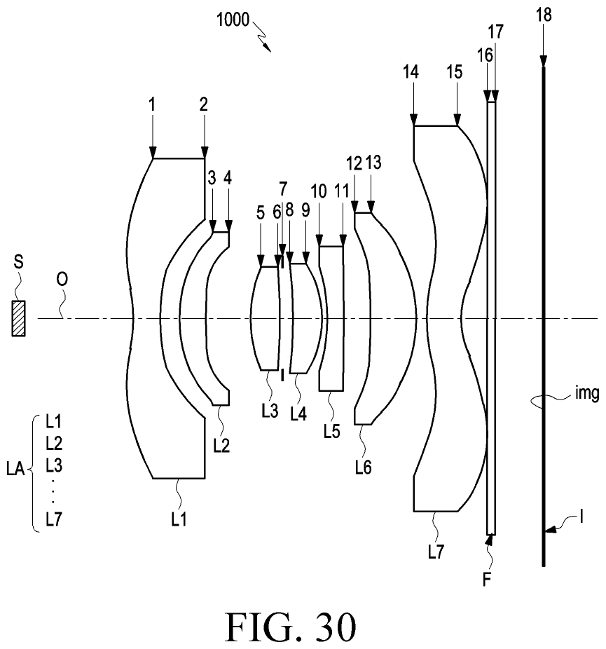

The camera modules 205, 212, and 213 of FIGS. 2 to 3 described above or the camera assembly 307 of FIG. 5 may be implemented by at least one of camera modules 400, 500, 600, 700, 800, 900, and 1000 in FIGS. 6, 10, 14, 18, 22, and 26, and/or FIG. 30 described below. Therefore, in the detailed description below, reference may be made to the electronic devices 200 and 300 of the preceding embodiments, and it should be noted that the same reference numerals or no reference numerals may be assigned to components which may be easily understood through the preceding embodiments in the drawings, and their detailed description may also be avoided.

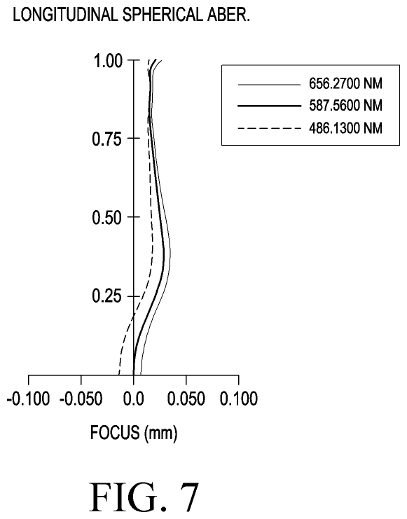

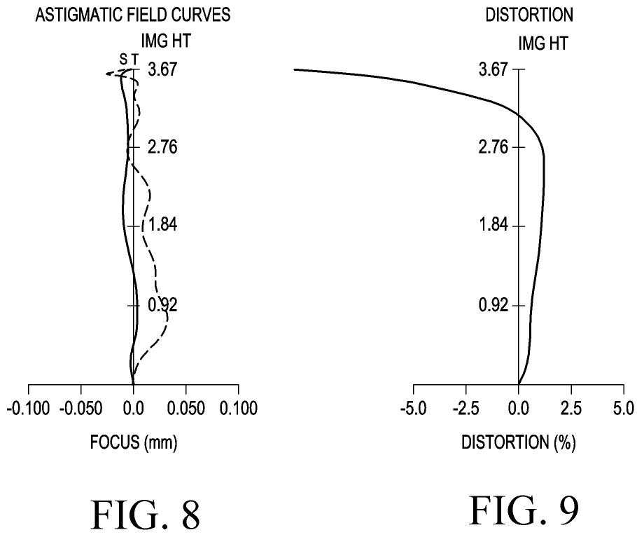

FIG. 6 is a diagram illustrating the camera module 400 and/or a lens assembly LA according to an embodiment of the disclosure. FIG. 7 is a graph illustrating spherical aberration of the lens assembly LA of FIG. 6 according to an embodiment of the disclosure. FIG. 8 is a graph illustrating astigmatism of the lens assembly LA of FIG. 6 according to an embodiment of the disclosure. FIG. 9 is a graph illustrating distortion of the lens assembly LA of FIG. 6 according to an embodiment of the disclosure.

FIG. 7 is a graph illustrating spherical aberration of the camera module 400 and/or the lens assembly LA according to an embodiment of the disclosure, in which the horizontal axis represents coefficients of longitudinal spherical aberration, the vertical axis represents normalized distances from an optical axis, and changes in the longitudinal spherical aberration according to wavelengths of light are illustrated. The longitudinal spherical aberration is represented, for example, for light having wavelengths of 656.2700 nanometer (NM), 587.5600NM, and 486.1300NM, respectively. FIG. 8 is a graph illustrating astigmatism of the camera module 400 and/or the lens assembly LA according to an embodiment of the disclosure, for light having a wavelength of 587.5600NM, wherein ‘X’ or ‘S’ denotes a sagittal plane by solid lines, and ‘Y’ or ‘T’ denotes a tangential plane or meridional plane by dotted lines. FIG. 9 is a graph illustrating distortion of the camera module 400 and/or the lens assembly LA according to an embodiment of the disclosure, for light having a wavelength of 587.5600NM. The refractive indexes of lens(s) mentioned in the following embodiment may refer to refractive indexes for light having a wavelength of approximately 587.5600 nm.

Referring to FIGS. 6 to 9, the camera module 400 according to an embodiment of the disclosure may include an image sensor I and the lens assembly LA. The lens assembly LA may include, for example, at least seven lenses L1, L2, L3, LA, L5, L6, and L7.

According to an embodiment, the lenses L1, L2, L3, LA, L5, L6, and L7 may be arranged sequentially along an optical axis O from an object S side to an image sensor I side. For example, the lenses L1, L2, L3, L4, L5, L6, and L7 may be substantially aligned with the image sensor I along the optical axis O. In the embodiments described below, the ordinal numbers, ‘first’, ‘second’, ‘third’, ‘fourth’, ‘fifth’, ‘sixth’, and ‘seventh’ assigned to the lenses L1, L2, L3, LA, L5, L6, and L7 may refer to the order in which they are arranged in a direction from the object S side toward the image sensor I. In an embodiment, in the camera module 400 and/or the lens assembly LA, an aperture stop (or stop) may be disposed between the second lens L2 and the third lens L3 or between the third lens L3 and the fourth lens LA. In the illustrated embodiment(s), the aperture stop of the camera module 400 and/or the lens assembly LA may be understood to be disposed between the third lens L3 and the fourth lens LA.

According to an embodiment, an optical component such as an IR cut filter F may be disposed between at least one of the seven lenses L1, L2, L3, L4, L5, L6, and L7 and the image sensor I. The IR cut filter F may be disposed between the seventh lens L7 and the image sensor I. The IR cut filter F may suppress or block light (e.g., IR light) of a wavelength that is not visible to the naked eye of a user but is detected by a photosensitive material of a film or the image sensor I from being incident on the image sensor I. Depending on the purpose of the camera module 400, the IR cut filter F may be replaced with a bandpass filter that transmits IR light and suppresses or blocks visible light. In an embodiment, the IR cut filter F may be implemented with a coating material disposed on a surface of any one of the lenses L1, L2, L3, LA, L5, L6, and L7.

In the following detailed description, the first lens L1 may be referred to as the “first lens on the object S side” or a “lens disposed farthest from the image sensor I”, and the seventh lens L7 may be referred to as the “first lens on the image sensor I side” or a “lens disposed closest to the image sensor I.” In an embodiment, “aligned along the optical axis O” may refer to being aligned such that the optical axes of the respective lenses L1, L2, L3, LA, L5, L6, and L7 or the optical axis of the image sensor I (e.g., an imaging plane img) coincide with each other. The imaging plane img may receive or detect light aligned or focused by, for example, the lenses L1, L2, L3, L4, L5, L6, and L7. For example, the imaging plane img may be understood as an active area of the image sensor I.

According to an embodiment, a processor (e.g., the processor 120 of FIG. 1) or an image signal processor may obtain an image of an object (e.g., the object S) by detecting light focused or guided by the lens assembly LA using the image sensor I (e.g., the imaging plane img). In an embodiment, the processor (e.g., the processor 120 of FIG. 1) may perform a focus adjustment operation and/or a focal length adjustment operation by linearly moving at least one of the lenses L1, L2, L3, L4, L5, L6, and L7 along the optical axis O with respect to the image sensor I. In an embodiment, the processor (e.g., the processor 120 of FIG. 1) may perform a hand tremor correction operation by horizontally moving at least one of the lenses L1, L2, L3, L4, L5, L6, and L7 or the image sensor I parallel to a plane perpendicular to the optical axis O. In an embodiment, the processor may enable the electronic device to receive or detect external light using the image sensor I, while performing the focus adjustment and/or hand tremor correction operation by executing at least some of instruction(s) stored in memory (e.g., the memory 130 of FIG. 1). For example, the memory may store instruction(s) that enable the electronic device to receive at least a portion of light focused on the image sensor I and obtain an image of the object S based on the received light, and these instruction(s) may be executed by the processor(s).

In the embodiment(s) described below, although lens surface numbers are written as numerals in the drawings, a symbol (or alphabet) ‘S’ may be added to the lens surface numbers so that they may be more clearly distinguished from the lenses L1, L2, L3, LA, L5, L6, and L7 in the detailed description. Although some of the reference numerals given to the lens surfaces in the drawings are not directly mentioned, those skilled in the art will easily understand the configurations of the respective lenses L1, L2, L3, L4, L5, L6, and L7 or lens surfaces based on lens data presented through [Tables] described below. For example, a lens surface indicated by reference numeral ‘7’ in the drawings and indicated by ‘S7’ in the [Tables] described below may refer to an aperture stop. In describing various embodiments below, the reference numerals of some of the object-side surface(s) and sensor-side surface(s) of the lenses L1, L2, L3, L4, L5, L6, and L7, and optical components (e.g., the IR cut filter F or the image sensor I (e.g., the imaging plane img)) may be omitted in the drawings, for simplicity of the drawings. The configurations of different embodiments may be applied for reference numerals of lens surfaces, optical components, or the imaging plane, which are omitted in the drawings, and the reference numerals may be easily understood through the following [Tables] regarding lens data of each embodiment.

In the detailed description of the embodiment(s) of the disclosure, the term ‘concave’ or ‘convex’ used to describe the object-side surfaces or sensor-side surfaces of the lenses L1, L2, L3, LA, L5, L6, and L7 may refer to the shape of a lens surface at a point intersecting the optical axis O or at a paraxial region intersecting the optical axis O. The term ‘concave’ may refer to a shape in which the lens surface is curved with a lens thickness decreasing from the paraxial region toward the optical axis. The term ‘convex’ may refer to a shape in which the lens surface is curved with a lens thickness increasing from the paraxial region toward the optical axis O.

Further, in the following detailed description, the radiuses (e.g., radiuses of curvature) of the lenses L1, L2, L3, L4, L5, L6, and L7, an effective focal length f, an overall length (OAL), a total track length (TTL), an air gap, a thickness, or the image height of the image sensor I in the disclosure may all have values in units of mm, unless otherwise specified. The ‘OAL’ is the distance from an object-side surface of the first lens on the object side to a sensor-side surface of the first lens on the image sensor side, measured on the optical axis O, and the ‘TTL’ is the distance from a top end of a barrel in which the lenses are arranged or fixed to the imaging plane img of the image sensor I, which may be measured parallel to the optical axis O. In addition, the radiuses, effective focal lengths, OAL, air gaps, or thicknesses of the lenses L1, L2, L3, LA, L5, L6, and L7 may be distances measured based on the optical axis O, and/or the height of the image sensor I may be a distance measured along a direction substantially perpendicular to the optical axis O from a point intersecting the optical axis O.

According to an embodiment, among the lenses L1, L2, L3, L4, L5, L6, and L7, the lens disposed first from the object S side, for example, the first lens L1 disposed farthest from the image sensor I, may have negative refractive power. In an embodiment, the first lens L1 may include a convex sensor-side surface S2.

According to an embodiment, among the lenses L1, L2, L3, L4, L5, L6, and L7, the second lens L2 may be disposed between the first lens L1 and the image sensor I and have positive refractive power. In an embodiment, the second lens L2 may include a convex object-side surface S3.

According to an embodiment, among the lenses L1, L2, L3, LA, L5, L6, and L7, the third lens L3 may be disposed between the second lens L2 and the image sensor I and have positive refractive power. In an embodiment, the third lens L3 may include a convex object-side surface S5.

According to an embodiment, among the lenses L1, L2, L3, L4, L5, L6, and L7, the fourth lens LA may be disposed between the third lens L3 and the image sensor I and have positive refractive power or negative refractive power.

According to an embodiment, among the lenses L1, L2, L3, L4, L5, L6, and L7, the fifth lens L5 may be disposed between the fourth lens L4 and the image sensor I and have negative refractive power. In an embodiment, the fifth lens L5 may include a concave sensor-side surface S11.

According to an embodiment, among the lenses L1, L2, L3, LA, L5, L6, and L7, the sixth lens L6 may be disposed between the fifth lens L5 and the image sensor I and have positive refractive power. In an embodiment, the sixth lens L6 may include a concave object-side surface S12.

According to an embodiment, among the lenses L1, L2, L3, L4, L5, L6, and L7, the seventh lens L7 may refer to the lens disposed closest to the image sensor I. In an embodiment, the seventh lens L7 may be disposed between the sixth lens L6 and the image sensor I and have negative refractive power.

According to an embodiment, the IR cut filter F may be disposed between the seventh lens L7 and the image sensor I. As described above, the IR cut filter F may block light in a wavelength band that is not detected by the naked eye of the user but is detected by a photosensitive material or the image sensor I. In an embodiment, when the camera module 400 functions as a camera that detects light in an IR wavelength band, the IR cut filter F may be replaced with a bandpass filter, and/or may be implemented as a coating material disposed on a lens surface of any one of the lenses L1, L2, L3, L4, L5, L6, and L7.

In an embodiment, the camera module 400 and/or the lens assembly LA may satisfy the condition presented by the following [Equation 1] regarding a focal length ‘f’ of the lens assembly LA and a focal length ‘f6’ of the sixth lens L6.

$$\frac{f}{f 6} \leq 1 \qquad [ Equation 1 ]$$

In an embodiment, [Equation 1] presents a condition regarding the specifications of the sixth lens L6 according to the focal length ‘f’ of the lens assembly LA, and when a value calculated by [Equation 1] exceeds approximately 1, the focal length of the sixth lens L6 may be shortened, and the curvature of the sixth lens L6 may be increased. In an embodiment, when the focal length of the sixth lens L6 is shortened and/or the curvature of the sixth lens L6 is increased, there may be difficulties in aligning the sixth lens L6 with the optical axis or managing the inclination of the sixth lens L6. When it is said that there are ‘difficulties in aligning on the optical axis O or managing inclination’, this may mean that a tolerance error range is narrowed during molding or processing of the sixth lens L6 into a designed shape or during assembly or arrangement of the sixth lens L6 manufactured as a good product. For example, [Equation 1] may be understood as presenting a condition for securing ease of manufacturing and/or ease of assembly, when the lens assembly LA is miniaturized and has a high resolution. In an embodiment, in the camera module 400 and/or the lens assembly LA, the calculated value of [Equation 1] may be approximately 0.45 or more and approximately 0.85 or less.

In an embodiment, the camera module 400 and/or the lens assembly LA may satisfy the condition presented by the following [Equation 2] regarding an Abbe number ‘vd2’ of the second lens L2.

$$25 \leq vd 2 \leq 45 \qquad [ Equation 2 ]$$

In an embodiment, the second lens L2 may have an Abbe number of approximately 40 or less (e.g., an Abbe number at d-line (wavelength of 587.5618 nm)), and when the condition presented by [Equation 2] is satisfied, the chromatic aberration correction of the camera module 400 and/or the lens assembly LA may be facilitated. In an embodiment, the second lens L2 may have a refractive index of approximately 1.55 or more, while satisfying the condition presented by [Equation 2].

In an embodiment, the camera module 400 and/or the lens assembly LA may satisfy the condition presented by the following [Equation 3] regarding the shape of the first lens L1. [Equation 3] may be understood as presenting a condition regarding, for example, a radius of curvature ‘r1’ of an object-side surface S1 of the first lens L1 and a radius of curvature ‘r2’ of the sensor-side surface S2 of the first lens L1.

$$- 3 \leq \frac{r 1 + r 2}{r 1 - r 2} \leq - 1.05 \qquad [ Equation 3 ]$$

In an embodiment, the radiuses of curvature of the lens surfaces S1 and S2 of the first lens L1 may be understood as, for example, the radiuses of curvature at points intersecting the optical axis O. In an embodiment, when a value calculated by [Equation 3] is less than approximately −3, the curvature of the sensor-side surface S2 of the first lens L1 increases and the refractive power of the first lens L1 increases, so that the refractive angle of downward light passing through the first lens L1 increases, making it difficult to secure the amount of light incident on the periphery. In an embodiment, when the calculated value of [Equation 3] is greater than approximately −1.05, the curvature of the sensor-side surface S2 of the first lens L1 decreases and the refractive power decreases, so that the aperture of the first lens L1 may increase. For example, [Equation 3] may be understood as presenting a condition for miniaturizing the camera module 400 and/or the lens assembly LA while securing a desired amount of light by using the shape or refractive power of the first lens L1. In an embodiment, the calculated value of [Equation 3] regarding the specifications of the lens assembly LA and/or the first lens L1 may be approximately −2.0 or more and approximately −1.3 or less.

According to an embodiment, the refractive index of at least one of the first lens L1, the third lens L3, the fourth lens LA, and/or the sixth lens L6 may be approximately 1.53 or more and approximately 1.55 or less. In an embodiment, at least one of the first lens L1, the third lens L3, the fourth lens LA, and/or the sixth lens L6 may be understood to have a lower refractive index than the other lens(s) (e.g., the second lens L2, the fifth lens L5, and/or the seventh lens L7). In an embodiment, the Abbe number of at least one of the first lens L1, the third lens L3, the fourth lens LA, and/or the sixth lens L6 may be approximately 50 or more and approximately 60 or less. In an embodiment, at least one of the first lens L1, the third lens L3, the fourth lens LA, and/or the sixth lens L6 may be understood to have a greater Abbe number than the other lens(s) (e.g., second lens L2, the fifth lens L5 and/or the seventh lens L7).

According to an embodiment, at least one of the second lens L2, the fifth lens L5, and/or the seventh lens L7 may have a refractive index of approximately 1.56 or more and approximately 1.68 or less. In an embodiment, at least one of the second lens L2, the fifth lens L5, and/or the seventh lens L7 may be understood to have a greater refractive index than the other lens(s) (e.g., the first lens L1, the third lens L3, the fourth lens LA, and/or the sixth lens L6). In an embodiment, the Abbe number of at least one of the fifth lens L5 and/or the seventh lens L7 may be approximately 18 or more and approximately 40 or less. In an embodiment, at least one of the fifth lens L5 and/or the seventh lens L7 may be understood to have a lower Abbe number than the other lens(s) (e.g., the first lens L1, the third lens L3, the fourth lens LA, and/or the sixth lens L6).

According to an embodiment, the above combinations of the refractive indexes and/or Abbe numbers of the lenses L1, L2, L3, L4, L5, L6, and L7 may implement stable optical performance while increasing the resolution of the lens assembly LA. In an embodiment, in increasing the resolution of the lens assembly LA, the first lens L1, the third lens L3, the fourth lens LA, and/or the sixth lens L6 may be understood to have a lower refractive index than the second lens L2, the fifth lens L5, and the seventh lens L7. In an embodiment, in increasing the resolution of the lens assembly LA, the first lens L1, the third lens L3, the fourth lens LA, and/or the sixth lens L6 may be understood to have a larger Abbe number than the fifth lens L5 and/or the seventh lens L7.

According to an embodiment, the camera module 400 and/or the lens assembly LA may have a focal length of approximately 2.2 mm, an F-number of approximately 1.98, and a total lens length of approximately 6.08 mm. In an embodiment, the angle of view of the lens assembly LA may be approximately 123.8 degrees. In an embodiment, the camera module 400 and/or the lens assembly LA may satisfy at least some of the above-described condition(s), and may be manufactured to the specifications exemplified in the following [Table 1]. In [Table 1], ‘focal length EFL’ may be a focal length at e-line (wavelength of 546.0740 nm).

TABLE 1

| Lens | Radius of | | Focal | Refractive | Abbe |
|---|---|---|---|---|---|
| surface | curvature | Thickness | length | index | number |
| (Surf) | (Radius) | (Thick) | (EFL) | (nd) | (vd) |
| Obj | infinity | Infinity | | | |
| S1* | −1.366 | 0.443 | −3.18 | 1.5440 | 56.0 |
| S2* | −7.268 | 0.285 | | | |
| S3* | 1.737 | 0.459 | 6.29 | 1.5672 | 37.4 |
| S4* | 3.062 | 0.578 | | | |
| S5* | 2.467 | 0.454 | 4.08 | 1.5440 | 56.0 |
| S6* | −20.929 | 0.000 | | | |
| S7(stop) | infinity | 0.126 | | | |
| S8* | 28.107 | 0.460 | 3.49 | 1.5440 | 56.0 |
| S9* | −2.026 | 0.035 | | | |
| S10* | −7.697 | 0.236 | −5.05 | 1.6608 | 20.4 |
| S11* | 5.961 | 0.422 | | | |
| S12* | −7.545 | 0.682 | 4.62 | 1.5440 | 56.0 |
| S13* | −1.944 | 0.120 | | | |
| S14* | 1.539 | 0.570 | −8.28 | 1.6144 | 25.9 |
| S15* | 1.015 | 0.399 | | | |
| S16 | infinity | 0.110 | infinity | 1.5168 | 64.2 |
| S17 | infinity | 0.680 | | | |
| Img | infinity | 0 | | | |

A symbol ‘*’ added for a lens surface in [Table 1] indicates an example of an aspherical surface, the aspherical surface coefficients of the lenses L1, L2, L3, L4, L5, L6, and L7 are listed in [Table 2], [Table 3], [Table 4], and [Table 5] below, and the definition of an aspherical surface is given by the following [Equation 4].

$$x = \frac{{y}^{2} / R}{1 + \sqrt{1 - ( 1 + K ) {( y / R )}^{2}}} + {\sum }_{i} ( {A}_{i} ) ( {y}^{i} ) \qquad [ Equation 4 ]$$

In [Equation 4], “x” is a distance in the direction of the optical axis O from a point where the optical axis O passes on a lens surface, “y” is a distance from the optical axis O in the direction perpendicular to the optical axis O, ‘R’ represents a radius of curvature at the vertex of a lens, ‘K’ represents a conic constant, and ‘Ai’ represents an aspherical coefficient, which may be written as ‘A’, ‘B’, ‘C’, ‘D’, ‘E’, ‘F’, ‘G’, ‘H’, ‘J’, ‘K’, ‘L’, ‘M’, ‘N’, or ‘O’ depending on a notation method. In [Table 2], E+01 may represent 10¹, and E−02 may represent 10⁻². The radius of curvature R may represent, for example, a value indicating the degree of curvature at each point on a curved surface or a curve.

TABLE 2

| Lens | | | | |
|---|---|---|---|---|
| surface | | | | |
| (Surf) | 1_QCN | 2_QCN | 3_QCN | 4_QCN |
| Radius of | −1.36631E+00 | −7.26796E+00 | 1.73707E+00 | 3.06195E+00 |
| curvature | | | | |
| (Radius) | | | | |
| K(Conic) | −1.18413E+01 | 1.04834E+00 | −4.90261E−01 | 4.27734E+00 |
| A(4th)/C4 | 1.11098E+00 | 9.61831E−01 | 1.65286E−01 | 1.58929E−01 |
| B(6th)/C5 | −2.24199E−01 | −1.64755E−01 | −1.60443E−02 | 1.50134E−02 |
| C(8th)/C6 | 7.58786E−02 | 4.42945E−02 | −1.94141E−03 | −1.73811E−03 |
| D(10th)/C7 | −3.60256E−02 | −2.24708E−02 | −9.50357E−03 | −3.42205E−03 |
| E(12th)/C8 | 1.37600E−02 | 2.08995E−03 | −1.54983E−03 | −1.35660E−03 |
| F(14th)/C9 | −6.75933E−03 | −2.22361E−03 | −6.03629E−04 | −4.16697E−04 |
| G(16th)/C10 | 2.87357E−03 | 7.38182E−04 | 4.27388E−04 | 5.78770E−05 |
| H(18th)/C11 | −1.40904E−03 | 1.62565E−05 | 1.79044E−04 | 6.60637E−05 |
| J(20th)/C12 | 5.72075E−04 | 1.69148E−04 | 1.15931E−04 | 4.87530E−05 |
| K(22th)/C13 | −2.80097E−04 | 9.46816E−06 | −5.94426E−06 | 0.00000E+00 |
| L(24th)/C14 | 9.66168E−05 | −1.46204E−06 | −1.91255E−05 | 0.00000E+00 |
| M(26th)/C15 | −4.03617E−05 | 0.00000E+00 | −1.82633E−05 | 0.00000E+00 |
| N(28th)/C16 | 9.20801E−06 | 0.00000E+00 | 0.00000E+00 | 0.00000E+00 |
| O(30th)/C17 | 0.00000E+00 | 0.00000E+00 | 0.00000E+00 | 0.00000E+00 |

TABLE 3

| Lens surface | | | | |
|---|---|---|---|---|
| (Surf) | 5_QCN | 6_QCN | 8_QCN | 9_QCN |
| Radius of | 2.46666E+00 | −2.09292E+01 | 2.81069E+01 | −2.02640E+00 |
| curvature | | | | |
| (Radius) | | | | |
| K(Conic) | 2.10246E+00 | −6.00000E+01 | 6.88728E+01 | 8.81883E−01 |
| A(4th)/C4 | 2.21333E−03 | −2.50889E−02 | −2.16407E−02 | −4.58802E−02 |
| B(6th)/C5 | −3.56367E−03 | −2.82797E−03 | −9.56584E−04 | −4.54796E−04 |
| C(8th)/C6 | −1.12268E−03 | −5.04161E−05 | 8.42205E−04 | 5.05202E−04 |
| D(10th)/C7 | −1.98387E−04 | −2.39246E−05 | 2.75030E−04 | 4.61923E−04 |
| E(12th)/C8 | −6.18217E−05 | 3.94819E−05 | 7.04173E−05 | 7.23830E−05 |
| F(14th)/C9 | −7.32918E−06 | −5.91541E−06 | 1.39451E−05 | 2.34482E−05 |
| G(16th)/C10 | −5.03002E−06 | 4.90140E−06 | −7.78899E−08 | −8.32180E−07 |
| H(18th)/C11 | 4.41381E−06 | 0.00000E+00 | 3.46472E−06 | 0.00000E+00 |
| J(20th)/C12 | 6.71290E−07 | 0.00000E+00 | 1.08359E−07 | 0.00000E+00 |
| K(22th)/C13 | 4.29186E−06 | 0.00000E+00 | 0.00000E+00 | 0.00000E+00 |
| L(24th)/C14 | 0.00000E+00 | 0.00000E+00 | 0.00000E+00 | 0.00000E+00 |
| M(26th)/C15 | 0.00000E+00 | 0.00000E+00 | 0.00000E+00 | 0.00000E+00 |
| N(28th)/C16 | 0.00000E+00 | 0.00000E+00 | 0.00000E+00 | 0.00000E+00 |
| O(30th)/C17 | 0.00000E+00 | 0.00000E+00 | 0.00000E+00 | 0.00000E+00 |

TABLE 4

| Lens surface | | | |
|---|---|---|---|
| (Surf) | 10_QCN | 11_QCN | 12_QCN |
| Radius of | −7.69656E+00 | 5.96113E+00 | −7.54531E+00 |
| curvature | | | |
| (Radius) | | | |
| K(Conic) | 3.50000E+01 | −1.76736E+01 | 1.32228E+01 |
| A(4th)/C4 | −4.54767E−02 | −1.11678E−01 | −1.29055E−01 |
| B(6th)/C5 | 6.01927E−04 | 1.62048E−02 | −1.35808E−02 |
| C(8th)/C6 | −1.72653E−04 | −1.15595E−03 | 2.49749E−02 |
| D(10th)/C7 | −4.29126E−05 | −2.72419E−04 | 3.40231E−03 |
| E(12th)/C8 | 2.03602E−05 | −6.22075E−05 | −3.14785E−03 |
| F(14th)/C9 | −1.26470E−05 | −9.54020E−05 | −1.99002E−03 |
| G(16th)/C10 | 8.22544E−06 | 5.80382E−05 | −2.20123E−05 |
| H(18th)/C11 | −5.65929E−06 | −1.05689E−05 | 5.18004E−04 |
| J(20th)/C12 | 3.95210E−06 | 2.26570E−05 | 2.08805E−04 |
| K(22th)/C13 | −2.29256E−06 | −1.52624E−05 | −3.64751E−05 |
| L(24th)/C14 | 8.88024E−07 | 7.58447E−06 | −7.12703E−05 |
| M(26th)/C15 | −2.06294E−07 | −6.44386E−06 | −7.24916E−06 |
| N(28th)/C16 | 2.58623E−08 | 3.10765E−06 | 8.00120E−06 |
| O(30th)/C17 | −1.34466E−09 | −2.87442E−06 | 1.22949E−05 |

TABLE 5

| Lens surface | | | |
|---|---|---|---|
| (Surf) | 13_QCN | 14_QCN | 15_QCN |
| Radius of | −1.94410E+00 | 1.53850E+00 | 1.01473E+00 |
| curvature | | | |
| (Radius) | | | |
| K(Conic) | −4.07698E−01 | −1.08136E+00 | −9.19536E−01 |
| A(4th)/C4 | −4.28502E−02 | −1.69073E−02 | −3.71493E−03 |
| B(6th)/C5 | −3.01436E−03 | 8.54271E−04 | 5.98402E−05 |
| C(8th)/C6 | 1.38569E−02 | −5.11140E−05 | −1.11930E−06 |
| D(10th)/C7 | 2.36405E−02 | 2.60889E−06 | 1.76621E−08 |
| E(12th)/C8 | −6.27066E−03 | −1.04843E−07 | −2.17461E−10 |
| F(14th)/C9 | −1.94023E−03 | 3.22336E−09 | 2.03704E−12 |
| G(16th)/C10 | −3.06261E−03 | −7.49834E−11 | −1.43886E−14 |
| H(18th)/C11 | 1.98560E−04 | 1.20969E−12 | 7.61178E−17 |
| J(20th)/C12 | 4.23851E−04 | −1.69899E−14 | 1.25191E−18 |
| K(22th)/C13 | 4.86856E−04 | 1.62010E−16 | −1.32815E−18 |
| L(24th)/C14 | 1.29273E−04 | 3.52366E−19 | −1.09775E−18 |
| M(26th)/C15 | −6.23597E−05 | 3.95734E−18 | 3.76083E−19 |
| N(28th)/C16 | −3.59912E−05 | 4.75863E−18 | 2.36830E−18 |
| O(30th)/C17 | −3.43792E−05 | 2.14130E−18 | 1.65341E−18 |

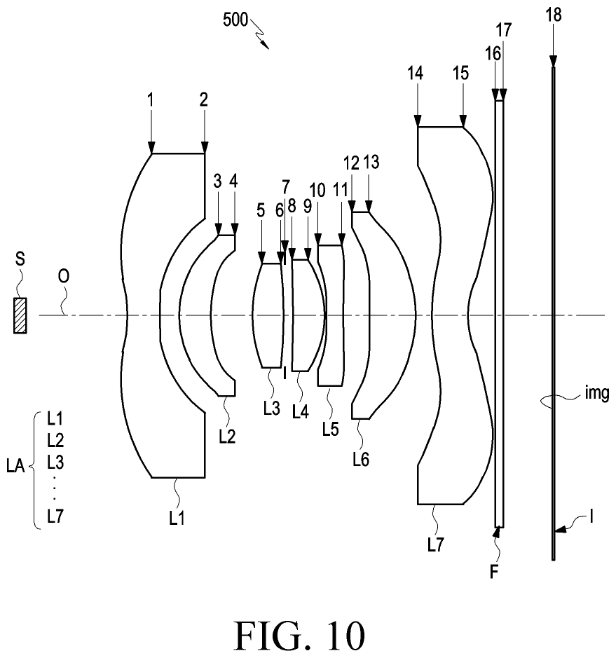

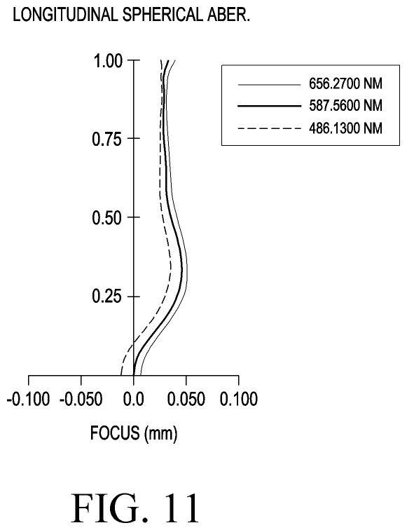

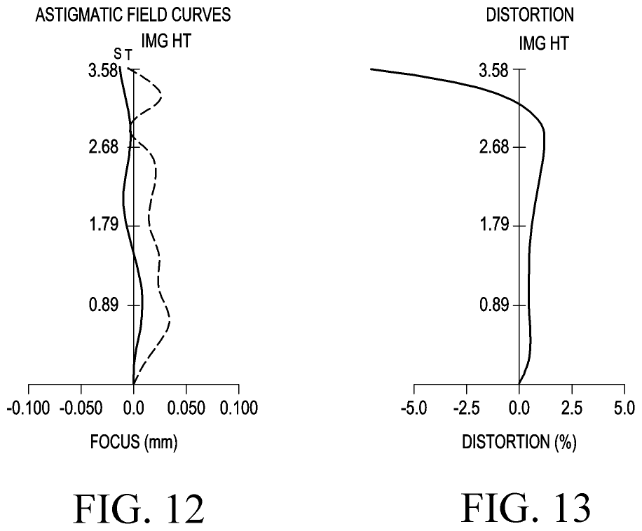

FIG. 10 is a diagram illustrating the camera module 500 and/or a lens assembly LA according to an embodiment of the disclosure. FIG. 11 is a graph illustrating spherical aberration of the lens assembly LA of FIG. 10 according to an embodiment of the disclosure. FIG. 12 is a graph illustrating astigmatism of the lens assembly LA of FIG. 10 according to an embodiment of the disclosure. FIG. 13 is a graph illustrating distortion of the lens assembly LA of FIG. 10 according to an embodiment of the disclosure.

The camera module 500 and/or the lens assembly LA in FIG. 10 may have a focal length of approximately 2.2 mm, an F-number of approximately 1.98, and a total lens length of approximately 6.08 mm. In an embodiment, the angle of view of the lens assembly LA may be approximately 120.0 degrees. In an embodiment, the camera module 500 and/or the lens assembly LA may satisfy at least some of the above-described condition(s), and may be manufactured to the specifications exemplified in the following [Table 6] and have the aspherical coefficients of [Table 7], [Table 8], [Table 9], and [Table 10].

TABLE 6

| Lens | Radius of | | Focal | Refractive | Abbe |
|---|---|---|---|---|---|
| surface | curvature | Thickness | length | index | number |
| (Surf) | (Radius) | (Thick) | (EFL) | (nd) | (vd) |
| obj | infinity | infinity | | | |
| S1* | −1.371 | 0.491 | −3.12 | 1.5440 | 56.0 |
| S2* | −7.985 | 0.242 | | | |
| S3* | 1.724 | 0.442 | 6.00 | 1.5672 | 37.4 |
| S4* | 3.174 | 0.640 | | | |
| S5* | 2.557 | 0.428 | 4.00 | 1.5440 | 56.0 |
| S6* | −13.730 | 0.010 | | | |
| S7(stop) | infinity | 0.118 | | | |
| S8* | 15.732 | 0.465 | 3.35 | 1.5440 | 56.0 |
| S9* | −2.037 | 0.032 | | | |
| S10* | −5.809 | 0.190 | −4.44 | 1.6504 | 21.5 |
| S11* | 5.824 | 0.421 | | | |
| S12* | −6.396 | 0.651 | 4.11 | 1.5349 | 55.7 |
| S13* | −1.695 | 0.217 | | | |
| S14* | 1.609 | 0.521 | −6.46 | 1.6144 | 25.9 |
| S15* | 1.004 | 0.402 | | | |
| S16 | infinity | 0.110 | infinity | 1.5168 | 64.2 |
| S17 | infinity | 0.668 | | | |
| img | infinity | 0.0000 | | | |

TABLE 7

| Lens surface (Surf) | 1_QCN | 2_QCN | 3_QCN | 4_QCN |
|---|---|---|---|---|
| Radius of curvature | −1.37125E+00 | −7.98523E+00 | 1.72419E+00 | 3.17355E+00 |
| (Radius) | | | | |
| K(Conic) | −1.13606E+01 | 1.61288E+00 | −4.29476E−01 | 4.97716E+00 |
| A(4th)/C4 | 1.10975E+00 | 6.86002E−02 | 1.72217E−01 | 1.59124E−01 |
| B(6th)/C5 | −2.16507E−01 | −5.11522E−03 | −1.52335E−02 | 2.12846E−02 |
| C(8th)/C6 | 7.11500E−02 | 4.65055E−04 | −2.90090E−03 | −7.11400E−04 |
| D(10th)/C7 | −3.32043E−02 | −3.72045E−05 | −1.14891E−02 | −3.48859E−03 |
| E(12th)/C8 | 1.25060E−02 | 1.89212E−06 | −1.79239E−03 | −1.56347E−03 |
| F(14th)/C9 | −6.01991E−03 | 3.17594E−08 | −4.28976E−04 | −5.12861E−04 |
| G(16th)/C10 | 2.60163E−03 | −1.51474E−08 | 6.88132E−04 | 4.51609E−05 |
| H(18th)/C11 | −1.20150E−03 | 1.28187E−09 | 3.17918E−04 | 7.52127E−05 |
| J(20th)/C12 | 4.99383E−04 | −5.50316E−11 | 1.41056E−04 | 6.65457E−05 |
| K(22th)/C13 | −2.24159E−04 | 1.21650E−12 | −2.72138E−05 | 0.00000E+00 |
| L(24th)/C14 | 7.93671E−05 | −1.07849E−14 | −4.32604E−05 | 0.00000E+00 |
| M(26th)/C15 | −3.17262E−05 | 0.00000E+00 | −2.39475E−05 | 0.00000E+00 |
| N(28th)/C16 | 2.71348E−06 | 0.00000E+00 | 0.00000E+00 | 0.00000E+00 |
| O(30th)/C17 | 0.00000E+00 | 0.00000E+00 | 0.00000E+00 | 0.00000E+00 |

TABLE 8

| Lens surface (Surf) | 5_QCN | 6_QCN | 8_QCN | 9_QCN |
|---|---|---|---|---|
| Radius of curvature | 2.55708E+00 | −1.37300E+01 | 1.57316E+01 | −2.03730E+00 |
| (Radius) | | | | |
| K(Conic) | 2.72577E+00 | −2.47141E+01 | −3.66462E+01 | 8.17433E−01 |
| A(4th)/C4 | 5.64595E−03 | −2.05463E−02 | −2.21362E−02 | −4.44214E−02 |
| B(6th)/C5 | −2.04869E−03 | −2.21054E−03 | −1.39711E−03 | −5.29447E−04 |
| C(8th)/C6 | −8.09164E−04 | −1.78934E−05 | 5.22399E−04 | 3.36099E−04 |
| D(10th)/C7 | −1.05423E−04 | −6.95513E−05 | 2.48370E−04 | 4.27089E−04 |
| E(12th)/C8 | −5.78010E−05 | 4.08158E−05 | 4.29653E−05 | 6.13268E−05 |
| F(14th)/C9 | 3.20691E−06 | −1.08948E−05 | 2.50424E−05 | 5.42286E−05 |
| G(16th)/C10 | −5.89238E−06 | 6.62111E−06 | −2.05849E−06 | 6.13467E−06 |
| H(18th)/C11 | 4.82105E−06 | 0.00000E+00 | 6.64706E−06 | −5.23564E−07 |
| J(20th)/C12 | −1.77798E−06 | 0.00000E+00 | 5.43867E−07 | 3.60325E−07 |
| K(22th)/C13 | 1.05332E−06 | 0.00000E+00 | −1.04530E−06 | 0.00000E+00 |
| L(24th)/C14 | 0.00000E+00 | 0.00000E+00 | −3.66122E−06 | 0.00000E+00 |
| M(26th)/C15 | 0.00000E+00 | 0.00000E+00 | 0.00000E+00 | 0.00000E+00 |
| N(28th)/C16 | 0.00000E+00 | 0.00000E+00 | 0.00000E+00 | 0.00000E+00 |
| O(30th)/C17 | 0.00000E+00 | 0.00000E+00 | 0.00000E+00 | 0.00000E+00 |

TABLE 9

| | Lens surface (Surf) | | |
|---|---|---|---|
| | 10_QCN | 11_QCN | 12_QCN |
| Radius of curvature | −5.80900E+00 | 5.82408E+00 | −6.39638E+00 |
| (Radius) | | | |
| K(Conic) | 3.04703E+01 | −1.21238E+01 | 1.24893E+01 |
| A(4th)/C4 | −4.81993E−02 | −2.45274E−02 | −1.16589E−01 |
| B(6th)/C5 | 2.02577E−03 | 1.66012E−03 | −1.07801E−02 |
| C(8th)/C6 | −3.36551E−04 | −1.15950E−04 | 1.54770E−02 |
| D(10th)/C7 | 4.68882E−05 | 1.03489E−05 | 5.14335E−03 |
| E(12th)/C8 | −1.67752E−05 | 3.01413E−06 | −1.52525E−03 |
| F(14th)/C9 | 5.34542E−06 | −3.51993E−06 | −1.34712E−03 |
| G(16th)/C10 | −1.76467E−06 | 2.12646E−06 | −3.83469E−04 |
| H(18th)/C11 | 4.78378E−07 | −9.20395E−07 | 2.50204E−04 |
| J(20th)/C12 | −7.21438E−07 | 2.76868E−07 | 1.75961E−04 |
| K(22th)/C13 | 6.91568E−07 | −5.58729E−08 | 5.06158E−05 |
| L(24th)/C14 | −3.09218E−07 | 7.36400E−09 | −4.32242E−05 |
| M(26th)/C15 | 7.13246E−08 | −6.06929E−10 | −1.33709E−05 |
| N(28th)/C16 | −8.28765E−09 | 2.83786E−11 | −7.12416E−06 |
| O(30th)/C17 | 3.84635E−10 | −5.74573E−13 | 1.51806E−05 |

TABLE 10

| | Lens surface (Surf) | | |
|---|---|---|---|
| | 13_QCN | 14_QCN | 15_QCN |
| Radius of curvature | −1.69504E+00 | 1.60933E+00 | 1.00394E+00 |
| (Radius) | | | |
| K(Conic) | −6.94203E−01 | −1.04435E+00 | −9.17642E−01 |
| A(4th)/C4 | 4.04202E−03 | −1.37816E−02 | −3.89532E−03 |
| B(6th)/C5 | −4.69947E−03 | 5.40984E−04 | 6.41363E−05 |
| C(8th)/C6 | 7.69091E−03 | −2.19677E−05 | −1.19460E−06 |
| D(10th)/C7 | 1.85169E−02 | 6.59909E−07 | 1.86390E−08 |
| E(12th)/C8 | −3.37381E−03 | −1.11245E−08 | −2.26468E−10 |
| F(14th)/C9 | −1.77673E−03 | −4.51667E−11 | 2.09335E−12 |
| G(16th)/C10 | −1.90042E−03 | 8.20320E−12 | −1.46047E−14 |
| H(18th)/C11 | −1.57035E−05 | −2.45173E−13 | 7.46778E−17 |
| J(20th)/C12 | 3.53686E−04 | 4.19074E−15 | −2.01594E−18 |
| K(22th)/C13 | 3.49501E−04 | −4.48589E−17 | 5.48877E−19 |
| L(24th)/C14 | 1.24270E−04 | 4.72983E−18 | −5.96211E−19 |
| M(26th)/C15 | −4.28770E−05 | 5.28549E−18 | −2.82231E−18 |
| N(28th)/C16 | −3.86729E−05 | 2.55465E−18 | −1.26335E−18 |
| O(30th)/C17 | −3.08380E−05 | 2.37169E−18 | −8.94467E−19 |

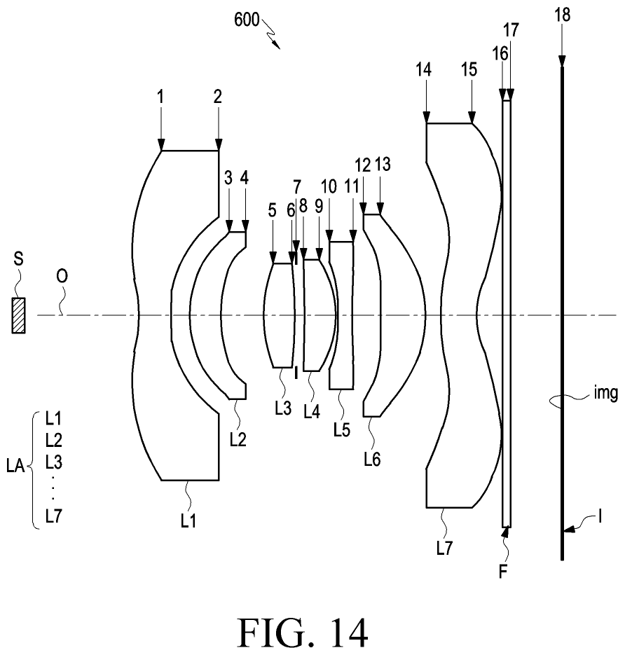

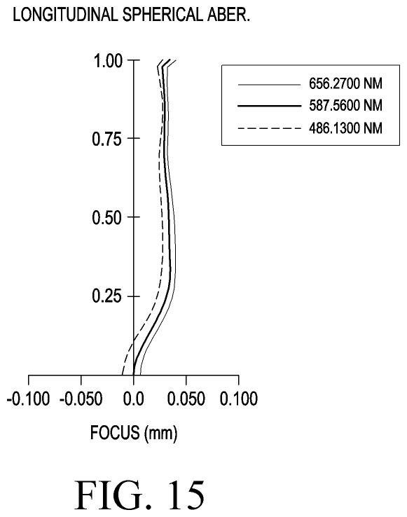

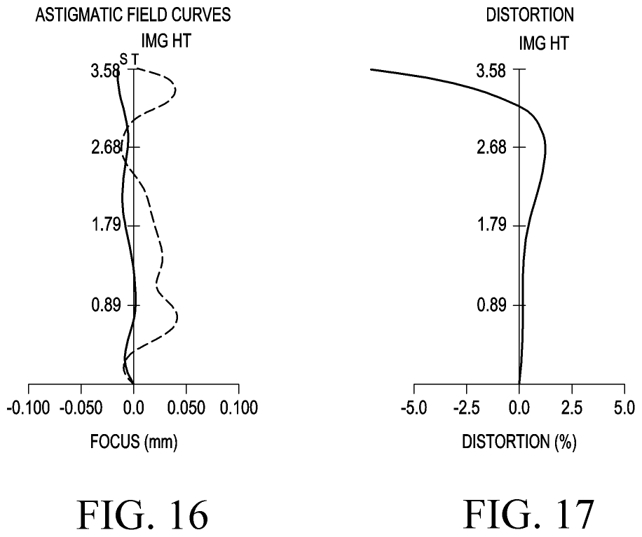

FIG. 14 is a diagram illustrating the camera module 600 and/or a lens assembly LA according to an embodiment of the disclosure. FIG. 15 is a graph illustrating spherical aberration of the lens assembly LA of FIG. 14 according to an embodiment of the disclosure. FIG. 16 is a graph illustrating astigmatism of the lens assembly LA of FIG. 14 according to an embodiment of the disclosure. FIG. 17 is a graph illustrating distortion of the lens assembly LA of FIG. 14 according to an embodiment of the disclosure.

The camera module 600 and/or the lens assembly LA in FIG. 14 may have a focal length of approximately 2.2 mm, an F-number of approximately 1.98, and a total lens length of approximately 6.08 mm. In an embodiment, the angle of view of the lens assembly LA may be approximately 119.9 degrees. In an embodiment, the camera module 600 and/or the lens assembly LA may satisfy at least some of the above-described condition(s), and may be manufactured to the specifications exemplified in the following [Table 11] and have the aspherical coefficients of [Table 12], [Table 13], [Table 14], and [Table 15].

TABLE 11

| Lens | Radius of | | Focal | Refractive | Abbe |
|---|---|---|---|---|---|
| surface | curvature | Thickness | length | index | number |
| (Surf) | (Radius) | (Thick) | (EFL) | (nd) | (vd) |
| obj | infinity | infinity | | | |
| S1* | −1.392 | 0.480 | −3.09 | 1.5440 | 56.0 |
| S2* | −9.131 | 0.234 | | | |
| S3* | 1.804 | 0.451 | 5.98 | 1.5672 | 37.4 |
| S4* | 3.507 | 0.645 | | | |
| S5* | 2.673 | 0.427 | 4.01 | 1.5440 | 56.0 |
| S6* | −11.124 | 0.022 | | | |
| S7(stop) | infinity | 0.100 | | | |
| S8* | 12.700 | 0.466 | 3.29 | 1.5440 | 56.0 |
| S9* | −2.053 | 0.041 | | | |
| S10* | −6.249 | 0.190 | −4.33 | 1.6504 | 21.5 |
| S11* | 5.176 | 0.429 | | | |
| S12* | −6.093 | 0.648 | 3.97 | 1.5349 | 55.7 |
| S13* | −1.633 | 0.217 | | | |
| S14* | 1.675 | 0.519 | −6.10 | 1.6144 | 25.9 |
| S15* | 1.021 | 0.371 | | | |
| S16 | infinity | 0.110 | infinity | 1.5168 | 64.2 |
| S17 | infinity | 0.698 | | | |
| img | infinity | 0 | | | |

TABLE 12

| Lens surface (Surf) | 1_QCN | 2_QCN | 3_QCN | 4_QCN |
|---|---|---|---|---|
| Radius of curvature | −1.39168E+00 | −9.12137E+00 | 1.80373E+00 | 3.50714E+00 |
| (Radius) | | | | |
| K(Conic) | −1.09273E+01 | 6.17211E+00 | −3.93646E−01 | 5.89453E+00 |
| A(4th)/C4 | 1.10830E+00 | 9.21261E−01 | 1.77329E−01 | 1.67639E−01 |
| B(6th)/C5 | −2.21005E−01 | −1.45352E−01 | −1.41081E−02 | 2.40516E−02 |
| C(8th)/C6 | 7.26165E−02 | 3.45528E−02 | −6.85866E−03 | −9.74021E−04 |
| D(10th)/C7 | −3.37118E−02 | −2.05051E−02 | −1.25332E−02 | −3.21660E−03 |
| E(12th)/C8 | 1.27336E−02 | 1.03401E−03 | −1.78474E−03 | −1.56916E−03 |
| F(14th)/C9 | −6.20734E−03 | −2.25475E−03 | −3.09553E−04 | −4.60944E−04 |
| G(16th)/C10 | 2.69224E−03 | 5.67881E−04 | 8.68457E−04 | 4.34746E−05 |
| H(18th)/C11 | −1.36926E−03 | −6.80642E−05 | 2.75448E−04 | 7.84673E−05 |
| J(20th)/C12 | 5.67189E−04 | 1.52136E−04 | 8.89919E−05 | 5.27145E−05 |
| K(22th)/C13 | −3.08443E−04 | −1.55159E−06 | −9.58263E−05 | 0.00000E+00 |
| L(24th)/C14 | 1.07831E−04 | 3.20856E−05 | −4.61113E−05 | 0.00000E+00 |
| M(26th)/C15 | −7.19316E−05 | 0.00000E+00 | −2.97099E−05 | 0.00000E+00 |
| N(28th)/C16 | 1.84468E−05 | 0.00000E+00 | 0.00000E+00 | 0.00000E+00 |
| O(30th)/C17 | −1.57380E−05 | 0.00000E+00 | 0.00000E+00 | 0.00000E+00 |

TABLE 13

| Lens surface (Surf) | 5_QCN | 6_QCN | 8_QCN | 9_QCN |
|---|---|---|---|---|
| Radius of curvature | 2.67201E+00 | −1.11238E+01 | 1.27001E+01 | −2.05320E+00 |
| (Radius) | | | | |
| K(Conic) | 3.01618E+00 | −4.94620E+01 | 5.00000E+01 | 7.73205E−01 |
| A(4th)/C4 | 6.93459E−03 | −2.10903E−02 | −2.45975E−02 | −4.35449E−02 |
| B(6th)/C5 | −1.91532E−03 | −1.76867E−03 | −1.56152E−03 | −5.73240E−04 |
| C(8th)/C6 | −6.98174E−04 | 1.33593E−04 | 7.38433E−04 | 3.59953E−04 |
| D(10th)/C7 | −7.15928E−05 | −1.41049E−05 | 2.52083E−04 | 6.28827E−04 |
| E(12th)/C8 | −3.66832E−05 | 5.09597E−05 | 8.79525E−05 | 5.14029E−05 |
| F(14th)/C9 | 4.23551E−06 | 7.62599E−07 | 1.33502E−05 | 5.56148E−05 |
| G(16th)/C10 | 3.23906E−06 | 1.28553E−05 | 1.08028E−05 | 9.86074E−06 |
| H(18th)/C11 | 2.77201E−06 | 0.00000E+00 | −9.81546E−06 | 6.48182E−06 |
| J(20th)/C12 | −2.57673E−06 | 0.00000E+00 | 7.19291E−07 | 6.95592E−06 |
| K(22th)/C13 | 7.98242E−07 | 0.00000E+00 | −6.60516E−06 | 0.00000E+00 |
| L(24th)/C14 | 0.00000E+00 | 0.00000E+00 | 3.79016E−06 | 0.00000E+00 |
| M(26th)/C15 | 0.00000E+00 | 0.00000E+00 | 0.00000E+00 | 0.00000E+00 |
| N(28th)/C16 | 0.00000E+00 | 0.00000E+00 | 0.00000E+00 | 0.00000E+00 |
| O(30th)/C17 | 0.00000E+00 | 0.00000E+00 | 0.00000E+00 | 0.00000E+00 |

TABLE 14

| | Lens surface (Surf) | | |
|---|---|---|---|
| | 10_QCN | 11_QCN | 12_QCN |
| Radius of curvature | −6.24900E+00 | 5.17648E+00 | −6.09298E+00 |
| (Radius) | | | |
| K(Conic) | 2.99634E+01 | −7.61503E+00 | 1.21560E+01 |
| A(4th)/C4 | −4.95377E−02 | −1.13874E−01 | −1.18384E−01 |
| B(6th)/C5 | 3.11545E−03 | 2.19151E−02 | −7.78747E−03 |
| C(8th)/C6 | −7.93645E−04 | −4.22854E−03 | 1.50623E−02 |
| D(10th)/C7 | 1.80966E−04 | 4.56830E−04 | 5.63359E−03 |
| E(12th)/C8 | −5.79941E−05 | −5.52344E−04 | −1.02377E−03 |
| F(14th)/C9 | 2.55738E−05 | −5.40901E−05 | −1.61262E−03 |
| G(16th)/C10 | −1.41652E−05 | −1.27732E−04 | −4.32107E−04 |
| H(18th)/C11 | 9.74524E−06 | −1.11920E−04 | 2.08684E−04 |
| J(20th)/C12 | −7.27124E−06 | −9.84335E−05 | 2.35202E−04 |
| K(22th)/C13 | 3.93698E−06 | −7.25328E−05 | 5.97403E−05 |
| L(24th)/C14 | −1.31522E−06 | −4.22569E−05 | −4.25962E−05 |
| M(26th)/C15 | 2.55333E−07 | −2.67827E−05 | −3.67953E−05 |
| N(28th)/C16 | −2.62934E−08 | −1.19174E−05 | −1.03978E−05 |
| O(30th)/C17 | 1.10254E−09 | −7.87073E−06 | 3.92553E−06 |

TABLE 15

| | Lens surface (Surf) | | |
|---|---|---|---|
| | 13_QCN | 14_QCN | 15_QCN |
| Radius of | −1.63292E+00 | 1.67480E+00 | 1.02089E+00 |
| curvature | | | |
| (Radius) | | | |
| K(Conic) | −7.33320E−01 | −1.01211E+00 | −9.15585E−01 |
| A(4th)/C4 | 1.07594E−02 | −1.21367E−02 | −3.80911E−03 |
| B(6th)/C5 | 3.29895E−03 | 4.94345E−04 | 6.11586E−05 |
| C(8th)/C6 | 8.19439E−03 | −1.98858E−05 | −1.12513E−06 |
| D(10th)/C7 | 1.85057E−02 | 6.18480E−07 | 1.74629E−08 |
| E(12th)/C8 | −2.94126E−03 | −1.20355E−08 | −2.11608E−10 |
| F(14th)/C9 | −2.28126E−03 | 5.20092E−11 | 1.95324E−12 |
| G(16th)/C10 | −2.05170E−03 | 4.68015E−12 | −1.36216E−14 |
| H(18th)/C11 | 1.37853E−04 | −1.61993E−13 | 7.48743E−17 |
| J(20th)/C12 | 4.56904E−04 | 2.89984E−15 | 5.73441E−18 |
| K(22th)/C13 | 4.42083E−04 | −3.03206E−17 | 1.82959E−18 |
| L(24th)/C14 | 8.84393E−05 | 6.64074E−19 | −7.08120E−19 |
| M(26th)/C15 | −6.90777E−05 | 1.15196E−18 | −3.18484E−19 |
| N(28th)/C16 | −1.02214E−04 | −3.13910E−18 | 2.75709E−18 |
| O(30th)/C17 | −3.57035E−05 | −2.52077E−18 | 2.36153E−18 |

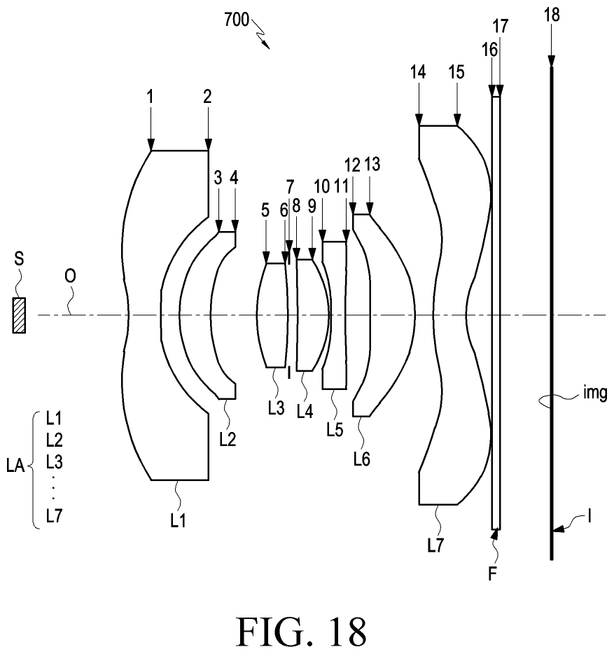

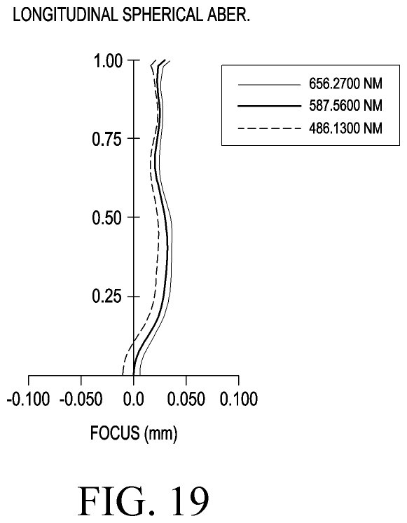

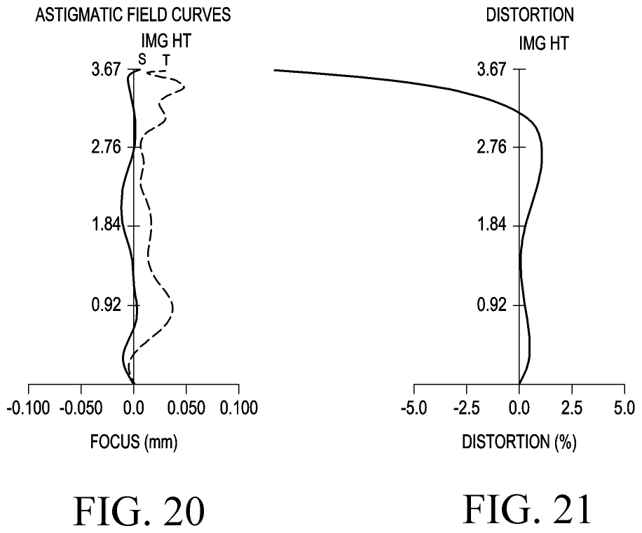

FIG. 18 is a diagram illustrating the camera module 700 and/or a lens assembly LA according to an embodiment of the disclosure. FIG. 19 is a graph illustrating spherical aberration of the lens assembly LA of FIG. 18 according to an embodiment of the disclosure. FIG. 20 is a graph illustrating astigmatism of the lens assembly LA of FIG. 18 according to an embodiment of the disclosure. FIG. 21 is a graph illustrating distortion of the lens assembly LA of FIG. 18 according to an embodiment of the disclosure.

The camera module 700 and/or the lens assembly LA in FIG. 18 may have a focal length of approximately 2.2 mm, an F-number of approximately 1.98, and a total lens length of approximately 6.08 mm. In an embodiment, the angle of view of the lens assembly LA may be approximately 124.1 degrees. In an embodiment, the camera module 700 and/or the lens assembly LA may satisfy at least some of the above-described condition(s), and may be manufactured to the specifications exemplified in the following [Table 16] and have the aspherical coefficients of [Table 17], [Table 18], [Table 19], and [Table 20].

TABLE 16

| Lens | Radius of | | Focal | Refractive | Abbe |
|---|---|---|---|---|---|
| surface | curvature | Thickness | length | index | number |
| (Surf) | (Radius) | (Thick) | (EFL) | (nd) | (vd) |
| obj | infinity | infinity | | | |
| S1* | −1.415 | 0.478 | −3.12 | 1.5440 | 56.0 |
| S2* | −9.577 | 0.224 | | | |
| S3* | 1.906 | 0.483 | 6.16 | 1.5672 | 37.4 |
| S4* | 3.805 | 0.656 | | | |
| S5* | 2.779 | 0.419 | 4.15 | 1.5440 | 56.0 |
| S6* | −11.440 | 0.022 | | | |
| S7(stop) | infinity | 0.111 | | | |
| S8* | 9.797 | 0.474 | 3.21 | 1.5440 | 56.0 |
| S9* | −2.085 | 0.048 | | | |
| S10* | −6.502 | 0.190 | −4.27 | 1.6504 | 21.5 |
| S11* | 4.896 | 0.391 | | | |
| S12* | −5.922 | 0.612 | 3.88 | 1.5349 | 55.7 |
| S13* | −1.593 | 0.284 | | | |
| S14* | 1.597 | 0.478 | −5.89 | 1.6144 | 25.9 |
| S15* | 0.982 | 0.377 | | | |
| S16 | infinity | 0.110 | infinity | 1.5168 | 64.2 |
| S17 | infinity | 0.700 | | | |
| img | infinity | 0 | | | |

TABLE 17

| Lens surface (Surf) | 1_QCN | 2_QCN | 3_QCN | 4_QCN |
|---|---|---|---|---|
| Radius of curvature | −1.41489E+00 | −9.57730E+00 | 1.90589E+00 | 3.80535E+00 |
| (Radius) | | | | |
| K(Conic) | −1.02173E+01 | 8.86570E+00 | −1.54527E−01 | 6.69423E+00 |
| A(4th)/C4 | 1.06994E+00 | 8.71809E−01 | 1.92414E−01 | 1.84027E−01 |
| B(6th)/C5 | −2.07971E−01 | −1.31642E−01 | −9.00514E−03 | 2.23820E−02 |
| C(8th)/C6 | 7.22183E−02 | 3.55662E−02 | −5.65275E−03 | −1.86104E−03 |
| D(10th)/C7 | −3.18430E−02 | −1.56760E−02 | −1.02236E−02 | −3.04850E−03 |
| E(12th)/C8 | 1.19710E−02 | 1.26745E−03 | −1.29993E−03 | −1.20160E−03 |
| F(14th)/C9 | −6.18955E−03 | −2.80832E−03 | −7.97000E−04 | −3.81336E−04 |
| G(16th)/C10 | 2.51525E−03 | −1.69283E−04 | 3.64158E−04 | 3.00675E−05 |
| H(18th)/C11 | −1.38745E−03 | −4.07087E−04 | −1.87116E−05 | 3.63658E−06 |
| J(20th)/C12 | 5.73969E−04 | 2.78533E−05 | 2.81506E−05 | 1.18337E−05 |
| K(22th)/C13 | −3.21711E−04 | 4.79111E−05 | −7.41269E−05 | −1.35216E−05 |
| L(24th)/C14 | 1.20763E−04 | 8.14176E−05 | 7.98598E−06 | 3.20326E−06 |
| M(26th)/C15 | −7.59183E−05 | 5.52978E−05 | −1.00115E−05 | 3.77725E−07 |
| N(28th)/C16 | 1.72347E−05 | 2.62812E−05 | 2.14695E−05 | 0.00000E+00 |
| O(30th)/C17 | −1.56846E−05 | 7.53108E−06 | −3.43571E−06 | 0.00000E+00 |

TABLE 18

| Lens surface (Surf) | 5_QCN | 6_QCN | 8_QCN | 9_QCN |
|---|---|---|---|---|
| Radius of curvature | 2.77917E+00 | −1.14398E+01 | 9.79749E+00 | −2.08519E+00 |
| (Radius) | | | | |
| K(Conic) | 2.77206E+00 | −6.11669E+01 | 1.27984E+01 | 1.10799E+00 |
| A(4th)/C4 | 6.22925E−03 | −2.40390E−02 | −2.86643E−02 | −4.87147E−02 |
| B(6th)/C5 | −2.64020E−03 | −2.35892E−03 | −2.45146E−03 | −1.90662E−03 |
| C(8th)/C6 | −6.87424E−04 | 1.92663E−04 | 7.22500E−04 | 6.11623E−04 |
| D(10th)/C7 | −6.25918E−05 | 6.27508E−05 | 3.40802E−04 | 5.77222E−04 |
| E(12th)/C8 | −2.28459E−05 | 6.77170E−05 | 9.02695E−05 | 8.92132E−05 |
| F(14th)/C9 | 6.25398E−06 | 1.47525E−05 | 2.80411E−05 | 1.79452E−05 |
| G(16th)/C10 | 6.85118E−06 | 1.24364E−05 | 4.09256E−06 | 4.53362E−05 |
| H(18th)/C11 | 3.39734E−06 | 2.03994E−06 | −8.22883E−06 | −2.01310E−05 |
| J(20th)/C12 | −9.60920E−07 | 0.00000E+00 | −1.93977E−06 | 1.63733E−05 |
| K(22th)/C13 | 8.81580E−07 | 0.00000E+00 | 0.00000E+00 | −9.74044E−06 |
| L(24th)/C14 | −1.73640E−06 | 0.00000E+00 | 0.00000E+00 | 7.91205E−06 |
| M(26th)/C15 | −3.94521E−07 | 0.00000E+00 | 0.00000E+00 | 1.38211E−06 |
| N(28th)/C16 | 0.00000E+00 | 0.00000E+00 | 0.00000E+00 | 3.93383E−06 |
| O(30th)/C17 | 0.00000E+00 | 0.00000E+00 | 0.00000E+00 | 9.64196E−08 |

TABLE 19

| | Lens surface (Surf) | | |
|---|---|---|---|
| | 10_QCN | 11_QCN | 12_QCN |
| Radius of curvature | −6.50231E+00 | 4.89556E+00 | −5.92238E+00 |
| (Radius) | | | |
| K(Conic) | 2.78773E+01 | −3.36504E+00 | 7.44509E+00 |
| A(4th)/C4 | −4.96972E−02 | −1.09644E−01 | −1.06894E−01 |
| B(6th)/C5 | 3.09283E−03 | 2.36554E−02 | −1.15261E−05 |
| C(8th)/C6 | −7.49354E−04 | −4.16787E−03 | 1.75721E−02 |
| D(10th)/C7 | 1.53425E−04 | 6.12988E−04 | 4.61362E−03 |
| E(12th)/C8 | −1.81893E−05 | −4.84672E−04 | −2.58712E−03 |
| F(14th)/C9 | −1.52869E−06 | 1.18789E−04 | −1.76119E−03 |
| G(16th)/C10 | 2.66600E−07 | −7.94679E−06 | 1.66044E−05 |
| H(18th)/C11 | 2.37624E−06 | −1.16244E−05 | 4.34874E−04 |
| J(20th)/C12 | −3.61478E−06 | −5.45110E−06 | 1.85790E−04 |
| K(22th)/C13 | 2.41832E−06 | −1.21237E−05 | −4.15331E−05 |
| L(24th)/C14 | −8.77613E−07 | −1.12163E−07 | −9.26135E−05 |
| M(26th)/C15 | 1.78880E−07 | −1.64602E−06 | −1.42490E−05 |
| N(28th)/C16 | −1.92372E−08 | −6.40383E−07 | 2.93907E−06 |
| O(30th)/C17 | 8.47696E−10 | −1.41210E−06 | 8.34765E−06 |

TABLE 20

| | Lens surface (Surf) | | |
|---|---|---|---|
| | 13_QCN | 14_QCN | 15_QCN |
| Radius of curvature | −1.59212E+00 | 1.59736E+00 | 9.82212E−01 |
| (Radius) | | | |
| K(Conic) | −9.73537E−01 | −1.03510E+00 | −9.19703E−01 |
| A(4th)/C4 | 5.39857E−02 | −2.38130E+00 | −4.04055E−03 |
| B(6th)/C5 | −6.00660E−04 | 4.83950E−01 | 6.37226E−05 |
| C(8th)/C6 | 1.01164E−02 | −1.27235E−01 | −1.14094E−06 |
| D(10th)/C7 | 1.52517E−02 | 5.72183E−02 | 1.74863E−08 |
| E(12th)/C8 | −4.05429E−03 | −3.68310E−02 | −2.12287E−10 |
| F(14th)/C9 | −2.56016E−03 | 1.52447E−02 | 1.98076E−12 |
| G(16th)/C10 | −9.40433E−04 | −3.96877E−03 | −1.40247E−14 |
| H(18th)/C11 | 4.52501E−04 | 3.24677E−03 | 7.59043E−17 |
| J(20th)/C12 | 4.70533E−04 | −7.39280E−04 | −1.32476E−18 |
| K(22th)/C13 | 2.20646E−04 | 9.11904E−04 | 2.57498E−19 |
| L(24th)/C14 | −3.52324E−05 | 1.76871E−06 | 3.67951E−18 |
| M(26th)/C15 | −9.55645E−05 | −2.90690E−05 | 3.29326E−18 |
| N(28th)/C16 | −5.00858E−05 | −1.46462E−04 | 5.71747E−20 |
| O(30th)/C17 | −1.16081E−05 | −7.93822E−05 | −1.19940E−18 |

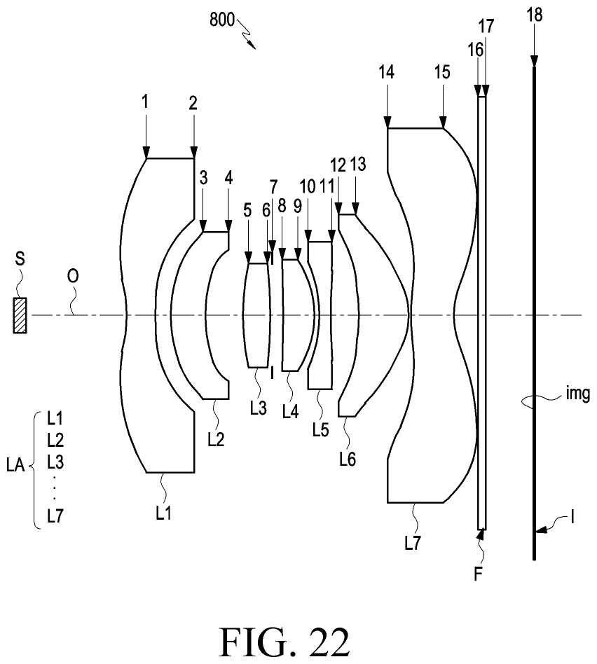

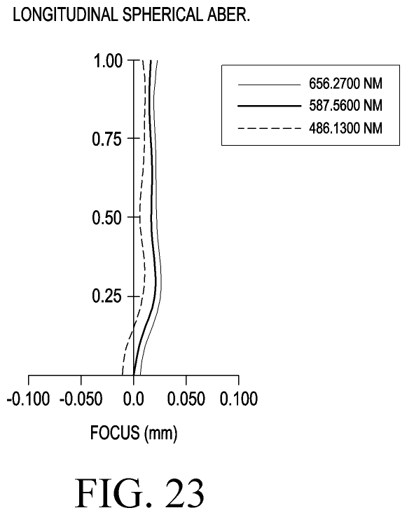

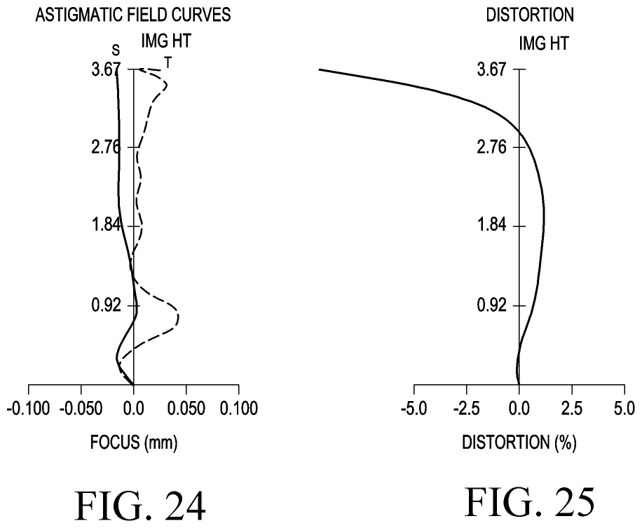

FIG. 22 is a diagram illustrating the camera module 800 and/or a lens assembly LA according to an embodiment of the disclosure. FIG. 23 is a graph illustrating spherical aberration of the lens assembly LA of FIG. 22 according to an embodiment of the disclosure. FIG. 24 is a graph illustrating astigmatism of the lens assembly LA of FIG. 22 according to an embodiment of the disclosure. FIG. 25 is a graph illustrating distortion of the lens assembly LA of FIG. 22 according to an embodiment of the disclosure.

The camera module 800 and/or the lens assembly LA in FIG. 22 may have a focal length of approximately 2.2 mm, an F-number of approximately 1.98, and a total lens length of approximately 6.09 mm. In an embodiment, the angle of view of the lens assembly LA may be approximately 122.8 degrees. In an embodiment, the camera module 800 and/or the lens assembly LA may satisfy at least some of the above-described condition(s), and may be manufactured to the specifications exemplified in the following [Table 21] and have the aspherical coefficients of [Table 22], [Table 23], [Table 24], and [Table 25].

TABLE 21

| Lens | Radius of | | Focal | Refractive | Abbe |
|---|---|---|---|---|---|
| surface | curvature | Thickness | length | index | number |
| (Surf) | (Radius) | (Thick) | (EFL) | (nd) | (vd) |
| obj | infinity | infinity | | | |
| S1* | −1.637 | 0.452 | −4.57 | 1.5440 | 56.0 |
| S2* | −5.252 | 0.212 | | | |
| S3* | 2.799 | 0.524 | 17.72 | 1.6144 | 25.9 |
| S4* | 3.499 | 0.550 | | | |
| S5* | 3.026 | 0.415 | 4.36 | 1.5440 | 56.0 |
| S6* | −10.450 | 0.031 | | | |
| S7(stop) | infinity | 0.120 | | | |
| S8* | 6.664 | 0.488 | 3.03 | 1.5440 | 56.0 |
| S9* | −2.134 | 0.098 | | | |
| S10* | −5.204 | 0.188 | −5.13 | 1.6504 | 21.5 |
| S11* | 9.112 | 0.392 | | | |
| S12* | −3.342 | 0.753 | 2.69 | 1.5440 | 56.0 |
| S13* | −1.100 | 0.025 | | | |
| S14* | 2.297 | 0.643 | −3.29 | 1.5672 | 37.4 |
| S15* | 0.926 | 0.367 | | | |
| S16 | infinity | 0.110 | infinity | 1.5168 | 64.2 |
| S17 | infinity | 0.701 | | | |
| img | infinity | 0.00 | | | |

TABLE 22

| Lens surface (Surf) | 1_QCN | 2_QCN | 3_QCN | 4_QCN |
|---|---|---|---|---|
| Radius of curvature | −1.63719E+00 | −5.25216E+00 | 2.79871E+00 | 3.49879E+00 |
| (Radius) | | | | |
| K(Conic) | −1.02216E+01 | −2.21136E+00 | −1.12698E−01 | 3.43353E+00 |
| A(4th)/C4 | 1.10738E+00 | 5.36001E−02 | 2.14477E−01 | 1.71670E−01 |
| B(6th)/C5 | −2.01988E−01 | −3.82082E−03 | −1.66512E−02 | 1.70071E−02 |
| C(8th)/C6 | 7.77921E−02 | 3.06150E−04 | −4.44431E−03 | −1.94616E−03 |
| D(10th)/C7 | −3.19951E−02 | −3.64881E−06 | −9.62768E−03 | −2.65019E−03 |
| E(12th)/C8 | 1.33945E−02 | −6.91007E−06 | −3.81085E−04 | −8.55484E−04 |
| F(14th)/C9 | −6.42910E−03 | 1.92475E−06 | −5.59927E−04 | −2.55239E−04 |
| G(16th)/C10 | 2.85122E−03 | −3.09911E−07 | 4.28431E−04 | 6.13159E−05 |
| H(18th)/C11 | −1.49227E−03 | 3.38055E−08 | 2.83633E−05 | 1.69907E−05 |
| J(20th)/C12 | 6.76970E−04 | −2.59148E−09 | 3.24809E−05 | 1.70260E−05 |
| K(22th)/C13 | −3.52137E−04 | 1.40118E−10 | −1.46493E−05 | 4.62712E−06 |
| L(24th)/C14 | 1.47917E−04 | −5.24340E−12 | 7.68960E−06 | 0.00000E+00 |
| M(26th)/C15 | −7.61345E−05 | 1.29450E−13 | 0.00000E+00 | 0.00000E+00 |
| N(28th)/C16 | 2.69980E−05 | −1.95768E−15 | 0.00000E+00 | 0.00000E+00 |
| O(30th)/C17 | −1.09611E−05 | 5.82759E−17 | 0.00000E+00 | 0.00000E+00 |

TABLE 23

| Lens surface (Surf) | 5_QCN | 6_QCN | 8_QCN | 9_QCN |
|---|---|---|---|---|
| Radius of curvature | 3.02583E+00 | −1.04496E+01 | 6.66437E+00 | −2.13359E+00 |
| (Radius) | | | | |
| K(Conic) | 7.41840E−01 | −4.67660E+01 | 3.50065E+01 | 6.15523E−01 |
| A(4th)/C4 | −1.05321E−03 | −2.79896E−02 | −2.46888E−02 | −1.86720E−02 |
| B(6th)/C5 | −4.76839E−03 | −1.92430E−03 | −1.61936E−03 | −1.38699E−03 |
| C(8th)/C6 | −1.07468E−03 | −4.40395E−05 | 3.91967E−04 | 1.09254E−04 |
| D(10th)/C7 | −1.59037E−04 | −2.37971E−05 | 2.02023E−04 | −5.21152E−06 |
| E(12th)/C8 | −1.96378E−05 | 1.46639E−05 | 3.56375E−05 | 2.43914E−05 |
| F(14th)/C9 | 4.12048E−06 | −5.08919E−06 | 1.41476E−05 | −1.72067E−05 |
| G(16th)/C10 | 8.42131E−06 | 7.21507E−07 | 0.00000E+00 | 1.09038E−05 |
| H(18th)/C11 | −3.05544E−06 | 1.45558E−06 | 0.00000E+00 | −3.75059E−06 |
| J(20th)/C12 | −2.97942E−06 | 0.00000E+00 | 0.00000E+00 | 5.97054E−07 |
| K(22th)/C13 | 0.00000E+00 | 0.00000E+00 | 0.00000E+00 | −3.10726E−08 |
| L(24th)/C14 | 0.00000E+00 | 0.00000E+00 | 0.00000E+00 | 0.00000E+00 |
| M(26th)/C15 | 0.00000E+00 | 0.00000E+00 | 0.00000E+00 | 0.00000E+00 |
| N(28th)/C16 | 0.00000E+00 | 0.00000E+00 | 0.00000E+00 | 0.00000E+00 |
| O(30th)/C17 | 0.00000E+00 | 0.00000E+00 | 0.00000E+00 | 0.00000E+00 |

TABLE 24

| Lens surface (Surf) | 10_QCN | 11_QCN | 12_QCN |
|---|---|---|---|
| Radius of curvature | −5.20412E+00 | 9.11207E+00 | −3.34166E+00 |
| (Radius) | | | |
| K(Conic) | 2.58522E+01 | 4.19571E+00 | 3.15913E+00 |
| A(4th)/C4 | −3.58913E−02 | −1.13468E−01 | −3.76379E−02 |
| B(6th)/C5 | 7.96211E−04 | 3.03706E−02 | 1.71858E−02 |
| C(8th)/C6 | −8.20361E−05 | −1.36849E−03 | 2.20278E−02 |
| D(10th)/C7 | 1.47529E−05 | −1.21144E−03 | −1.64761E−03 |
| E(12th)/C8 | −1.34187E−06 | −3.99382E−04 | −4.23772E−03 |
| F(14th)/C9 | 1.16291E−05 | 1.39182E−04 | −1.36439E−03 |
| G(16th)/C10 | −8.81118E−06 | 1.29936E−04 | 1.37173E−03 |
| H(18th)/C11 | 3.04322E−06 | −4.84966E−05 | 5.55516E−04 |
| J(20th)/C12 | −5.64351E−07 | −2.14825E−05 | −2.14310E−04 |
| K(22th)/C13 | 5.39931E−08 | −1.77211E−05 | −3.42931E−04 |
| L(24th)/C14 | −2.08942E−09 | 1.16602E−06 | −7.44056E−05 |
| M(26th)/C15 | 0.00000E+00 | 4.29946E−06 | 6.40018E−05 |
| N(28th)/C16 | 0.00000E+00 | 4.15009E−06 | 4.21355E−05 |
| O(30th)/C17 | 0.00000E+00 | −2.18852E−06 | 0.00000E+00 |

TABLE 25

| Lens surface (Surf) | 13_QCN | 14_QCN | 15_QCN |
|---|---|---|---|
| Radius of curvature | −1.09992E+00 | 2.29724E+00 | 9.25573E−01 |
| (Radius) | | | |
| K(Conic) | −1.13766E+00 | −8.75463E−01 | −9.25219E−01 |
| A(4th)/C4 | −3.67808E−03 | −1.64836E+00 | −4.23663E−03 |
| B(6th)/C5 | 1.12094E−03 | 3.45893E−01 | 6.70046E−05 |
| C(8th)/C6 | −2.31698E−04 | −8.83625E−02 | −1.22022E−06 |
| D(10th)/C7 | 4.93625E−05 | 3.84529E−02 | 1.88734E−08 |
| E(12th)/C8 | −9.14466E−06 | −1.84315E−02 | −2.28608E−10 |
| F(14th)/C9 | 1.20783E−06 | 7.44096E−03 | 2.10888E−12 |
| G(16th)/C10 | −1.37893E−07 | −2.45884E−03 | −1.46652E−14 |
| H(18th)/C11 | 1.05584E−08 | 1.40876E−03 | 7.71715E−17 |
| J(20th)/C12 | −5.82391E−10 | −6.36693E−04 | −4.00985E−18 |
| K(22th)/C13 | 2.28200E−11 | 3.70748E−04 | −1.89735E−18 |
| L(24th)/C14 | −6.17443E−13 | −1.46727E−04 | −6.50521E−19 |
| M(26th)/C15 | 1.09865E−14 | −1.26323E−05 | −7.58942E−19 |
| N(28th)/C16 | −1.31070E−16 | −5.81154E−05 | −1.49417E−18 |
| O(30th)/C17 | −2.02116E−16 | 2.90973E−05 | 5.75982E−19 |

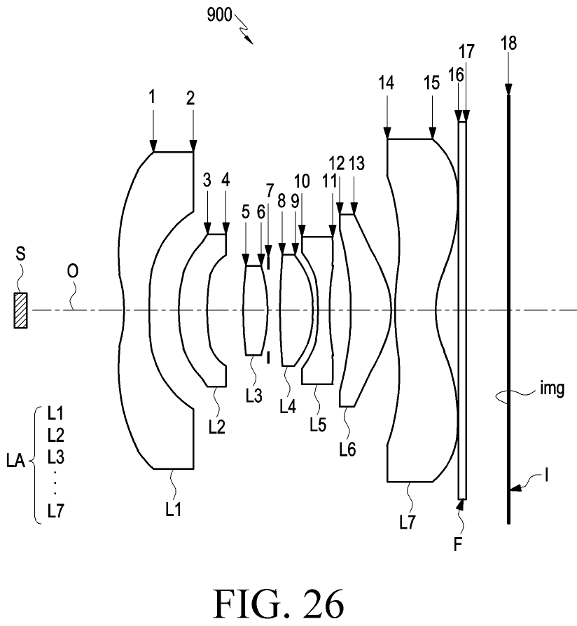

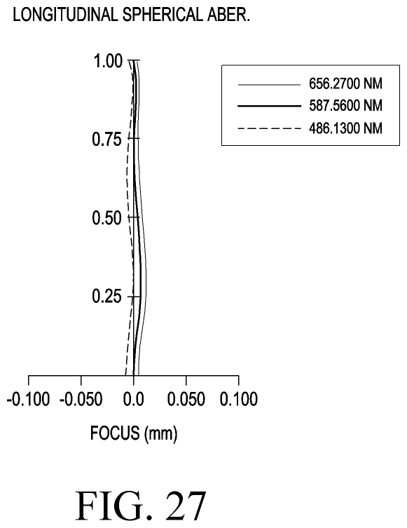

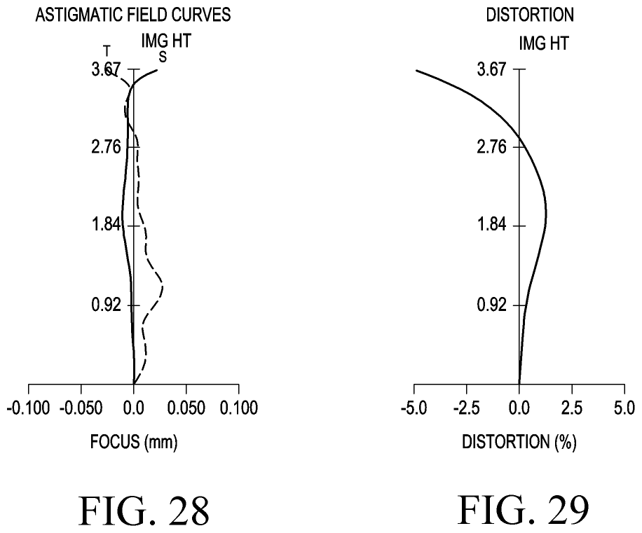

FIG. 26 is a diagram illustrating the camera module 900 and/or a lens assembly LA according to an embodiment of the disclosure. FIG. 27 is a graph illustrating spherical aberration of the lens assembly LA of FIG. 26 according to an embodiment of the disclosure. FIG. 28 is a graph illustrating astigmatism of the lens assembly LA of FIG. 26 according to an embodiment of the disclosure. FIG. 29 is a graph illustrating distortion of the lens assembly LA of FIG. 26 according to an embodiment of the disclosure.

The camera module 900 and/or the lens assembly LA in FIG. 26 may have a focal length of approximately 2.2 mm, an F-number of approximately 2.09, and a total lens length of approximately 6.49 mm. In an embodiment, the angle of view of the lens assembly LA may be approximately 121.8 degrees. In an embodiment, the camera module 900 and/or the lens assembly LA may satisfy at least some of the above-described condition(s), and may be manufactured to the specifications exemplified in the following [Table 26] and have the aspherical coefficients of [Table 27]. [Table 28]. [Table 29], and [Table 30].

TABLE 26

| Lens | Radius of | | Focal | Refractive | Abbe |
|---|---|---|---|---|---|
| surface | curvature | Thickness | length | index | number |
| (Surf) | (Radius) | (Thick) | (EFL) | (nd) | (vd) |
| obj | infinity | infinity | | | |
| S1* | −1.508 | 0.419 | −4.24 | 1.5349 | 55.7 |
| S2* | −4.941 | 0.464 | | | |
| S3* | 2.429 | 0.494 | 13.48 | 1.6144 | 25.9 |
| S4* | 3.172 | 0.614 | | | |
| S5* | 4.381 | 0.407 | 4.84 | 1.5440 | 56.0 |
| S6* | −6.373 | 0.010 | | | |
| S7(stop) | infinity | 0.197 | | | |
| S8* | 5.425 | 0.573 | 2.57 | 1.5440 | 56.0 |
| S9* | −1.815 | 0.077 | | | |
| S10* | −4.473 | 0.190 | −3.45 | 1.6349 | 24.0 |
| S11* | 4.374 | 0.369 | | | |
| S12* | −4.177 | 0.694 | 3.04 | 1.5440 | 56.0 |
| S13* | −1.254 | 0.053 | | | |
| S14* | 2.207 | 0.690 | −4.34 | 1.6144 | 25.9 |
| S15* | 1.096 | 0.406 | | | |
| S16 | infinity | 0.110 | infinity | 1.5168 | 64.2 |
| S17 | infinity | 0.719 | | | |
| img | infinity | 0.00 | | | |

TABLE 27

| Lens surface (Surf) | 1_QCN | 2_QCN | 3_QCN | 4_QCN |
|---|---|---|---|---|
| Radius of curvature | −1.50771E+00 | −4.94146E+00 | 2.42927E+00 | 3.17175E+00 |
| (Radius) | | | | |
| K(Conic) | −9.80689E+00 | −1.18079E+01 | −1.78154E+00 | 2.78671E+00 |
| A(4th)/C4 | 1.12090E−02 | 3.23691E−02 | 7.88115E−03 | 1.36780E−01 |
| B(6th)/C5 | −4.86296E−04 | −1.70998E−03 | −6.52171E−04 | 2.02960E−02 |
| C(8th)/C6 | 2.29885E−05 | 1.04248E−04 | 1.25950E−04 | 1.18896E−03 |
| D(10th)/C7 | −9.54146E−07 | −5.77575E−06 | −4.55421E−06 | −1.44697E−03 |
| E(12th)/C8 | 3.23615E−08 | 2.79644E−07 | −3.40554E−06 | −5.59610E−04 |
| F(14th)/C9 | −8.68530E−10 | −1.16670E−08 | 1.07850E−06 | −2.44626E−04 |
| G(16th)/C10 | 1.81209E−11 | 4.08367E−10 | −1.65937E−07 | 1.24911E−05 |
| H(18th)/C11 | −2.90217E−13 | −1.08948E−11 | 1.50434E−08 | 3.99748E−06 |
| J(20th)/C12 | 3.44805E−15 | 1.94266E−13 | −8.11666E−10 | 1.87285E−05 |
| K(22th)/C13 | −2.13425E−16 | −2.08974E−15 | 2.39676E−11 | 8.06945E−07 |
| L(24th)/C14 | 1.25327E−16 | −1.62901E−16 | −2.96954E−13 | 0.00000E+00 |
| M(26th)/C15 | −1.75824E−16 | 0.00000E+00 | 0.00000E+00 | 0.00000E+00 |
| N(28th)/C16 | −8.68446E−17 | 0.00000E+00 | 0.00000E+00 | 0.00000E+00 |
| O(30th)/C17 | 8.26433E−17 | 0.00000E+00 | 0.00000E+00 | 0.00000E+00 |

TABLE 28

| Lens surface (Surf) | 5_QCN | 6_QCN | 8_QCN | 9_QCN |
|---|---|---|---|---|
| Radius of curvature | 4.38136E+00 | −6.37279E+00 | 5.42480E+00 | −1.81512E+00 |
| (Radius) | | | | |
| K(Conic) | −1.88750E+01 | 1.43669E+01 | 2.82679E+01 | −4.59600E−01 |
| A(4th)/C4 | −1.25753E−02 | −3.19005E−02 | −2.01857E−02 | 6.61751E−03 |
| B(6th)/C5 | −3.46911E−03 | −6.13371E−04 | −8.48042E−04 | −6.04604E−03 |
| C(8th)/C6 | −4.60895E−04 | −6.67769E−06 | 5.26538E−05 | 1.18003E−03 |
| D(10th)/C7 | 1.37542E−05 | 1.74460E−05 | −1.24582E−05 | −2.61151E−04 |
| E(12th)/C8 | −1.76031E−05 | −2.48531E−06 | 9.35540E−06 | 5.91844E−05 |
| F(14th)/C9 | 1.00033E−05 | 6.08133E−06 | −2.29472E−06 | −1.14151E−05 |
| G(16th)/C10 | −7.28157E−06 | −3.65571E−06 | 2.44730E−07 | 2.05099E−06 |
| H(18th)/C11 | 6.36969E−06 | 4.49537E−07 | 0.00000E+00 | −4.05542E−07 |
| J(20th)/C12 | −1.27375E−06 | 0.00000E+00 | 0.00000E+00 | 7.48758E−08 |
| K(22th)/C13 | 0.00000E+00 | 0.00000E+00 | 0.00000E+00 | −8.70635E−09 |
| L(24th)/C14 | 0.00000E+00 | 0.00000E+00 | 0.00000E+00 | 4.33873E−10 |
| M(26th)/C15 | 0.00000E+00 | 0.00000E+00 | 0.00000E+00 | 0.00000E+00 |
| N(28th)/C16 | 0.00000E+00 | 0.00000E+00 | 0.00000E+00 | 0.00000E+00 |
| O(30th)/C17 | 0.00000E+00 | 0.00000E+00 | 0.00000E+00 | 0.00000E+00 |

TABLE 29

| | Lens surface (Surf) | | |
|---|---|---|---|
| | 10_QCN | 11_QCN | 12_QCN |
| Radius of | −4.47326E+00 | 4.37440E+00 | −4.17692E+00 |
| curvature | | | |
| (Radius) | | | |
| K(Conic) | 1.51516E+01 | 7.49459E+00 | 2.15346E+00 |
| A(4th)/C4 | −1.09859E−03 | −6.94604E−03 | 8.35977E−03 |
| B(6th)/C5 | −4.70365E−03 | −1.28907E−03 | −8.72481E−04 |
| C(8th)/C6 | 1.07388E−03 | 3.58355E−04 | 1.45078E−04 |
| D(10th)/C7 | −2.24018E−04 | −6.65154E−05 | −2.80379E−05 |
| E(12th)/C8 | 4.49767E−05 | 1.01266E−05 | 4.74901E−06 |
| F(14th)/C9 | −8.38655E−06 | −1.24012E−06 | −6.34814E−07 |
| G(16th)/C10 | 1.20299E−06 | 1.13840E−07 | 6.37749E−08 |
| H(18th)/C11 | −1.42290E−07 | −7.27543E−09 | −4.65763E−09 |
| J(20th)/C12 | 9.33730E−09 | 2.99711E−10 | 2.39810E−10 |
| K(22th)/C13 | −3.08873E−10 | −7.08976E−12 | −8.38761E−12 |
| L(24th)/C14 | 3.53830E−12 | 7.28709E−14 | 1.88485E−13 |
| M(26th)/C15 | 0.00000E+00 | 0.00000E+00 | −2.39710E−15 |
| N(28th)/C16 | 0.00000E+00 | 0.00000E+00 | 1.92507E−16 |
| O(30th)/C17 | 0.00000E+00 | 0.00000E+00 | 0.00000E+00 |

TABLE 30

| | Lens surface (Surf) | | |
|---|---|---|---|
| | 13_QCN | 14_QCN | 15_QCN |
| Radius of | −1.25416E+00 | 2.20686E+00 | 1.09635E+00 |
| curvature | | | |
| (Radius) | | | |
| K(Conic) | −1.74406E+00 | −9.56385E−01 | −9.08357E−01 |
| A(4th)/C4 | 1.52224E−03 | −9.00169E−03 | −2.77397E−03 |
| B(6th)/C5 | 7.74193E−05 | 2.39494E−04 | 3.59465E−05 |
| C(8th)/C6 | 1.34285E−05 | −2.86026E−06 | −5.32420E−07 |
| D(10th)/C7 | −4.11067E−06 | −4.03537E−07 | 6.68119E−09 |
| E(12th)/C8 | 5.88272E−07 | 3.76922E−08 | −6.61212E−11 |
| F(14th)/C9 | −5.47400E−08 | −1.82826E−09 | 5.03740E−13 |
| G(16th)/C10 | 3.35045E−09 | 5.86746E−11 | −2.92424E−15 |
| H(18th)/C11 | −1.28794E−10 | −1.21809E−12 | 1.39930E−17 |
| J(20th)/C12 | 2.66420E−12 | 2.10423E−14 | −1.48231E−19 |
| K(22th)/C13 | −5.19774E−15 | −2.37806E−16 | −2.33442E−18 |
| L(24th)/C14 | −1.36161E−15 | 3.77438E−18 | 7.14896E−19 |
| M(26th)/C15 | 2.50813E−16 | 4.31648E−18 | 1.35695E−18 |
| N(28th)/C16 | 1.65858E−16 | 5.06102E−18 | 7.42424E−19 |
| O(30th)/C17 | 9.78645E−17 | 3.32037E−19 | 3.38813E−21 |

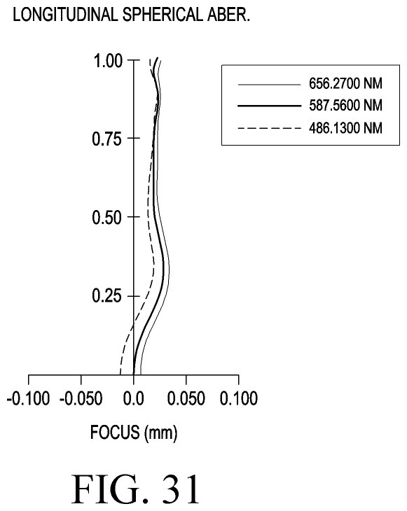

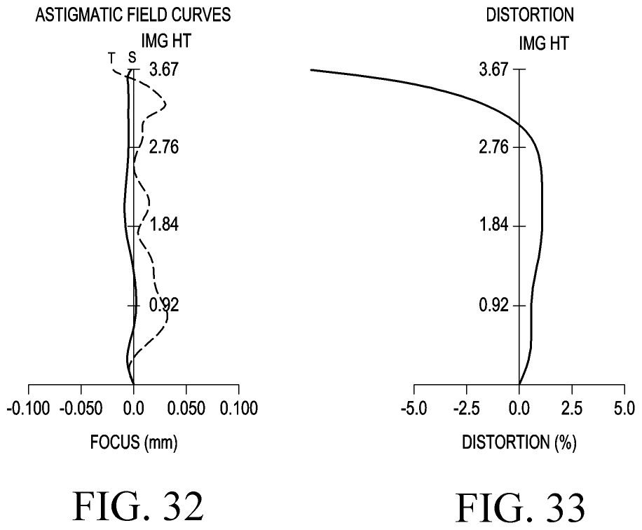

FIG. 30 is a diagram illustrating the camera module 1000 and/or a lens assembly LA according to an embodiment of the disclosure. FIG. 31 is a graph illustrating spherical aberration of the lens assembly LA of FIG. 30 according to an embodiment of the disclosure. FIG. 32 is a graph illustrating astigmatism of the lens assembly LA of FIG. 30 according to an embodiment of the disclosure. FIG. 33 is a graph illustrating distortion of the lens assembly LA of FIG. 30 according to an embodiment of the disclosure.

The camera module 1000 and/or the lens assembly LA in FIG. 30 may have a focal length of approximately 2.2 mm, an F-number of approximately 1.98, and a total lens length of approximately 6.08 mm. In an embodiment, the angle of view of the lens assembly LA may be approximately 123.1 degrees. In an embodiment, the camera module 1000 and/or the lens assembly LA may satisfy at least some of the above-described condition(s), and may be manufactured to the specifications exemplified in the following [Table 31] and have the aspherical coefficients of [Table 32], [Table 33], [Table 34], and [Table 35].

TABLE 31

| Lens | Radius of | | Focal | Refractive | Abbe |
|---|---|---|---|---|---|
| surface | curvature | Thickness | length | index | number |
| (Surf) | (Radius) | (Thick) | (EFL) | (nd) | (vd) |
| obj | infinity | infinity | | | |
| S1* | −1.402 | 0.400 | −3.38 | 1.5440 | 56.0 |
| S2* | −6.522 | 0.286 | | | |
| S3* | 2.699 | 0.390 | 7.41 | 1.5672 | 37.4 |
| S4* | 7.138 | 0.666 | | | |
| S5* | 2.282 | 0.438 | 3.73 | 1.5440 | 56.0 |
| S6* | −16.978 | 0.044 | | | |
| S7(stop) | infinity | 0.140 | | | |
| S8* | −34.948 | 0.439 | 4.10 | 1.5440 | 56.0 |
| S9* | −2.107 | 0.077 | | | |
| S10* | −14.929 | 0.230 | −5.37 | 1.6708 | 19.2 |
| S11* | 4.781 | 0.417 | | | |
| S12* | −6.747 | 0.683 | 4.46 | 1.5440 | 56.0 |
| S13* | −1.849 | 0.147 | | | |
| S14* | 1.406 | 0.513 | −7.68 | 1.6144 | 25.9 |
| S15* | 0.933 | 0.400 | | | |
| S16 | infinity | 0.110 | infinity | 1.5168 | 64.2 |
| S17 | infinity | 0.678 | | | |
| img | infinity | 0.00 | | | |

TABLE 32

| Lens surface (Surf) | 1_QCN | 2_QCN | 3_QCN | 4_QCN |
|---|---|---|---|---|
| Radius of curvature | −1.40232E+00 | −6.52218E+00 | 2.69870E+00 | 7.13807E+00 |
| (Radius) | | | | |
| K(Conic) | −1.28855E+01 | 5.52246E+00 | 4.39058E−02 | 9.64174E+00 |
| A(4th)/C4 | 1.04390E+00 | 9.86065E−01 | 2.05056E−02 | 2.41693E−01 |
| B(6th)/C5 | −2.13274E−01 | −1.80496E−01 | −2.32492E−03 | 1.96062E−02 |
| C(8th)/C6 | 7.75973E−02 | 4.77283E−02 | 4.66572E−04 | −6.50995E−03 |
| D(10th)/C7 | −3.43429E−02 | −2.10446E−02 | −7.07539E−05 | −4.95506E−03 |
| E(12th)/C8 | 1.37930E−02 | 3.73211E−03 | 1.26587E−05 | −8.39367E−04 |
| F(14th)/C9 | −6.43952E−03 | −2.23507E−03 | −2.64762E−06 | 1.46866E−04 |
| G(16th)/C10 | 2.73242E−03 | 3.52598E−04 | 4.77296E−07 | 2.44589E−04 |
| H(18th)/C11 | −1.21606E−03 | −2.08529E−04 | −5.87985E−08 | 4.05388E−05 |
| J(20th)/C12 | 5.24686E−04 | 1.77178E−04 | 4.47404E−09 | 4.87322E−07 |
| K(22th)/C13 | −2.14909E−04 | 8.59867E−05 | −1.99039E−10 | 0.00000E+00 |
| L(24th)/C14 | 7.38822E−05 | 2.88841E−05 | 4.69442E−12 | 0.00000E+00 |
| M(26th)/C15 | −1.28431E−05 | 0.00000E+00 | −4.42054E−14 | 0.00000E+00 |
| N(28th)/C16 | −7.19275E−06 | 0.00000E+00 | 0.00000E+00 | 0.00000E+00 |
| O(30th)/C17 | 0.00000E+00 | 0.00000E+00 | 0.00000E+00 | 0.00000E+00 |

TABLE 33

| Lens surface (Surf) | 5_QCN | 6_QCN | 8_QCN | 9_QCN |
|---|---|---|---|---|
| Radius of curvature | 2.28192E+00 | −1.69778E+01 | −3.49475E+01 | −2.10707E+00 |
| (Radius) | | | | |
| K(Conic) | 2.86017E+00 | −8.49337E+01 | 0.00000E+00 | 1.20798E+00 |
| A(4th)/C4 | 6.46899E−03 | −7.74824E−03 | −2.78180E−02 | −5.35449E−02 |
| B(6th)/C5 | −2.50219E−03 | −1.89851E−03 | −3.39130E−03 | −1.26133E−03 |
| C(8th)/C6 | −7.11033E−04 | −7.90331E−05 | 4.15150E−06 | −1.02654E−03 |
| D(10th)/C7 | −8.18968E−05 | −2.84541E−05 | 1.46208E−04 | 4.47777E−04 |
| E(12th)/C8 | −4.05466E−05 | 4.07121E−05 | 4.41648E−05 | −1.05958E−05 |
| F(14th)/C9 | 5.60073E−06 | −4.24770E−06 | 1.28201E−05 | 1.95587E−05 |
| G(16th)/C10 | −3.83263E−06 | 8.73904E−06 | 4.08764E−06 | 3.41745E−06 |
| H(18th)/C11 | 2.02767E−06 | 0.00000E+00 | 2.68986E−06 | 0.00000E+00 |
| J(20th)/C12 | −1.35123E−06 | 0.00000E+00 | 1.48920E−06 | 0.00000E+00 |
| K(22th)/C13 | 1.76881E−06 | 0.00000E+00 | 0.00000E+00 | 0.00000E+00 |
| L(24th)/C14 | 0.00000E+00 | 0.00000E+00 | 0.00000E+00 | 0.00000E+00 |
| M(26th)/C15 | 0.00000E+00 | 0.00000E+00 | 0.00000E+00 | 0.00000E+00 |
| N(28th)/C16 | 0.00000E+00 | 0.00000E+00 | 0.00000E+00 | 0.00000E+00 |
| O(30th)/C17 | 0.00000E+00 | 0.00000E+00 | 0.00000E+00 | 0.00000E+00 |

TABLE 34

| Lens surface (Surf) | 10_QCN | 11_QCN | 12_QCN |
|---|---|---|---|
| Radius of curvature | −1.49295E+01 | 4.78139E+00 | −6.74714E+00 |
| (Radius) | | | |
| K(Conic) | 4.00000E+01 | −1.59079E+01 | 2.27816E+00 |
| A(4th)/C4 | −5.08290E−02 | −1.23937E−01 | −1.02000E−01 |
| B(6th)/C5 | 2.69745E−03 | 2.09402E−02 | −1.89515E−02 |
| C(8th)/C6 | −5.54412E−04 | −3.16270E−03 | 2.31592E−02 |
| D(10th)/C7 | 4.70011E−05 | 5.45203E−04 | 3.07757E−03 |
| E(12th)/C8 | −8.01740E−06 | −2.03842E−04 | −2.37811E−03 |
| F(14th)/C9 | 4.68194E−06 | 5.85568E−06 | −1.55101E−03 |
| G(16th)/C10 | −2.42435E−07 | 1.61387E−05 | 1.12886E−04 |
| H(18th)/C11 | −3.25207E−06 | −6.75884E−06 | 3.43676E−04 |
| J(20th)/C12 | 2.91128E−06 | 7.68286E−06 | 1.70941E−04 |
| K(22th)/C13 | −1.20524E−06 | −7.10724E−06 | −5.14335E−05 |
| L(24th)/C14 | 3.50429E−07 | 6.61541E−06 | −4.22605E−05 |
| M(26th)/C15 | −5.73405E−08 | −7.49837E−06 | −2.42529E−06 |
| N(28th)/C16 | 5.29928E−09 | 2.29976E−06 | 4.08649E−06 |
| O(30th)/C17 | −2.12660E−10 | −1.33106E−06 | 1.46758E−05 |

TABLE 35

| Lens surface (Surf) | 13_QCN | 14_QCN | 15_QCN |
|---|---|---|---|
| Radius of curvature | −1.84872E+00 | 1.40565E+00 | 9.32666E−01 |
| (Radius) | | | |
| K(Conic) | −7.74382E−01 | −1.13512E+00 | −9.22995E−01 |
| A(4th)/C4 | 3.45556E−02 | −2.40067E+00 | −4.22926E−03 |
| B(6th)/C5 | −2.68471E−02 | 5.09201E−01 | 6.97612E−05 |
| C(8th)/C6 | 8.28283E−03 | −1.26578E−01 | −1.27598E−06 |
| D(10th)/C7 | 2.22470E−02 | 5.43695E−02 | 1.92438E−08 |
| E(12th)/C8 | −5.65758E−03 | −3.58181E−02 | −2.24441E−10 |
| F(14th)/C9 | −4.67896E−04 | 1.56955E−02 | 1.98554E−12 |
| G(16th)/C10 | −2.28950E−03 | −6.81277E−03 | −1.32320E−14 |
| H(18th)/C11 | 2.03335E−04 | 3.92935E−03 | 6.57128E−17 |
| J(20th)/C12 | 2.34989E−04 | −2.22339E−03 | −3.08151E−18 |
| K(22th)/C13 | 3.24887E−04 | 1.18069E−03 | −2.23617E−18 |
| L(24th)/C14 | 7.52516E−05 | −3.28218E−04 | 1.25361E−19 |
| M(26th)/C15 | −6.80363E−06 | 2.49366E−04 | 3.18823E−18 |
| N(28th)/C16 | −2.27637E−05 | −8.06293E−05 | 2.27428E−18 |
| O(30th)/C17 | −3.92939E−06 | 2.57497E−05 | 1.01644E−19 |

The calculated values of the [Equations] for the above-described camera modules 400, 500, 600, 700, 800, 900, and 1000 and/or the lens assembly LA are listed in [Table 36] below. As described in [Table 36], the camera modules 400, 500, 600, 700, 800, 900, and 1000 and/or the lens assembly LA according to the embodiment(s) of the disclosure may satisfy at least some of the above-described conditions including the [Equations]. For example, the camera modules 400, 500, 600, 700, 800, 900, and 1000 and/or the lens assembly LA according to the embodiment(s) of the disclosure may be miniaturized, while providing improved resolution, wide-angle performance, or improved ultra-wide-angle performance.

TABLE 36

| | Embodiment | Embodiment | Embodiment | Embodiment | Embodiment | Embodiment | Embodiment |
|---|---|---|---|---|---|---|---|
| | of FIG. 6 | of FIG. 10 | of FIG. 14 | of FIG. 18 | of FIG. 22 | of FIG. 26 | of FIG. 30 |
| Equation 1 | 0.48 | 0.54 | 0.56 | 0.57 | 0.82 | 0.71 | 0.49 |
| Equation 2 | 37.4 | 37.4 | 37.4 | 37.4 | 25.9 | 25.9 | 37.4 |
| Equation 3 | −1.46 | −1.41 | −1.36 | −1.35 | −1.91 | −1.88 | −1.55 |

In an embodiment, the camera modules 400, 500, 600, 700, 800, 900, and 1000 and/or the lens assembly LA according to the embodiment(s) of the disclosure may provide a high resolution required for an image sensor including a greater number (e.g., about 50 million or more) of pixels in an active area (e.g., the imaging plane img of FIG. 6) of the same size (e.g., area) by satisfying at least some of the above-described condition(s), and implement an angle of view of approximately 120 degrees.

The effects obtainable in the disclosure are not limited to the effects mentioned above, and other effects not mentioned will be clearly understood by those skilled in the art from the above description of the embodiment(s).

According to an embodiment of the disclosure, a camera module (e.g., the camera modules 205, 212, and 213 of FIGS. 2 and 3, the camera assembly 307 of FIGS. 4 and 5, and the camera module 400, 500, 600, 700, 800, 900, or 1000 of FIG. 6, FIG. 10, FIG. 14, FIG. 18, FIG. 22, FIG. 26, and/or FIG. 30) may include an image sensor (e.g., the image sensor I of FIG. 6, FIG. 10, FIG. 14, FIG. 18, FIG. 22, FIG. 26, and/or FIG. 30), and a lens assembly (e.g., the lens assembly LA FIG. 6, FIG. 10, FIG. 14, FIG. 18, FIG. 22, FIG. 26, and/or FIG. 30) including at least seven lenses (e.g., the lenses L1, L2, L3, L4, L5, L6, and L7 FIG. 6, FIG. 10, FIG. 14, FIG. 18, FIG. 22, FIG. 26, and/or FIG. 30) aligned along an optical axis (e.g., the optical axis O of FIG. 6, FIG. 10, FIG. 14, FIG. 18, FIG. 22, FIG. 26, and/or FIG. 30) and configured to focus or guide light incident from outside the camera module to the image sensor. In an embodiment, the at least seven lenses may include a first lens (e.g., the first lens L1 of FIG. 6, FIG. 10, FIG. 14, FIG. 18, FIG. 22, FIG. 26, and/or FIG. 30) disposed farthest from the image sensor, including a convex sensor-side surface, and having negative refractive power, a second lens (e.g., the second lens L2 of FIG. 6, FIG. 10, FIG. 14, FIG. 18, FIG. 22, FIG. 26, and/or FIG. 30) disposed between the first lens and the image sensor and having positive refractive power, a third lens (e.g., the third lens L3 of FIG. 6, FIG. 10, FIG. 14, FIG. 18, FIG. 22, FIG. 26, and/or FIG. 30) disposed between the second lens and the image sensor and having positive refractive power, a fourth lens (e.g., the fourth lens LA of FIG. 6, FIG. 10, FIG. 14, FIG. 18, FIG. 22, FIG. 26, and/or FIG. 30) disposed between the third lens and the image sensor and having positive refractive power or negative refractive power, a fifth lens (e.g., the fifth lens L5 of FIG. 6, FIG. 10, FIG. 14, FIG. 18, FIG. 22, FIG. 26, and/or FIG. 30) disposed between the fourth lens and the image sensor and having negative refractive power, a sixth lens (e.g., the sixth lens L6 of FIG. 6, FIG. 10, FIG. 14, FIG. 18, FIG. 22, FIG. 26, and/or FIG. 30) disposed between the fifth lens and the image sensor, including a concave object-side surface, and having positive refractive power, and a seventh lens (e.g., the seventh lens L7 of FIG. 6, FIG. 10, FIG. 14, FIG. 18, FIG. 22, FIG. 26, and/or FIG. 30) disposed between the sixth lens and the image sensor and having negative refractive power. In an embodiment, the lens assembly may satisfy the following [Conditional Expression 1; f/f6<=1] regarding a focal length ‘f’ of the lens assembly and a focal length ‘f6’ of the sixth lens.

According to an embodiment, the lens assembly may satisfy the following [Conditional Expression 2; 25<=vd2<=45] regarding an Abbe number ‘vd2’ of the second lens.

According to an embodiment, the lens assembly may satisfy the following [Conditional Expression 3; −3<=(r1+r2)/(r1−r2)<=−1.05] regarding a radius of curvature ‘r1’ of an object-side surface of the first lens, and a radius of curvature ‘r2’ of the sensor-side surface of the first lens.

According to an embodiment, the fifth lens may include a concave sensor-side surface.

According to an embodiment, the third lens may include a convex object-side surface.

According to an embodiment, a refractive index of at least one of the first lens, the third lens, the fourth lens, or the sixth lens may be 1.53 or more and 1.55 or less.

According to an embodiment, an Abbe number of at least one of the first lens, the third lens, the fourth lens, or the sixth lens may be 50 or more and 60 or less.

According to an embodiment, a refractive index of at least one of the second lens, the fifth lens, or the seventh lens may be 1.56 or more and 1.68 or less.

According to an embodiment, an Abbe number of at least one of the fifth lens or the seventh lens may be 18 or more and 40 or less.

According to an embodiment, refractive indexes of the first lens, the third lens, the fourth lens, and the sixth lens may be 1.53 or more and 1.55 or less, Abbe numbers of the first lens, the third lens, the fourth lens, and the sixth lens may be 50 or more and 60 or less, refractive indexes of the second lens, the fifth lens, and the seventh lens may be 1.56 or more and 1.68 or less, and Abbe numbers of the fifth lens and the seventh lens may be 18 or more and 40 or less.

According to an embodiment of the disclosure, an electronic device (e.g., the electronic devices 101, 200, and 300 of FIGS. 1 to 5) may include a camera module (e.g., the camera modules 205, 212, and 213 of FIGS. 2 and 3, the camera assembly 307 of FIGS. 4 and 5, and the camera module 400, 500, 600, 700, 800, 900, or 1000 of FIG. 6, FIG. 10, FIG. 14, FIG. 18, FIG. 22, FIG. 26, and/or FIG. 30), at least one processor (e.g., the processor 120 of FIG. 1), and memory (e.g., the memory 130 of FIG. 1) storing instructions configured to, when executed by the at least one processor, enable the electronic device to obtain an object image using the camera module. According to an embodiment, the camera module may include an image sensor (e.g., the image sensor I of FIG. 6, FIG. 10, FIG. 14, FIG. 18, FIG. 22, FIG. 26, and/or FIG. 30), and a lens assembly (e.g., the lens assembly LA FIG. 6, FIG. 10, FIG. 14, FIG. 18, FIG. 22, FIG. 26, and/or FIG. 30) including at least seven lenses (e.g., the lenses L1, L2, L3, L4, L5, L6, and L7 FIG. 6, FIG. 10, FIG. 14, FIG. 18, FIG. 22, FIG. 26, and/or FIG. 30) aligned along an optical axis (e.g., the optical axis O of FIG. 6, FIG. 10, FIG. 14, FIG. 18, FIG. 22, FIG. 26, and/or FIG. 30) and configured to focus or guide light incident from outside the camera module to the image sensor. In an embodiment, the at least seven lenses may include a first lens (e.g., the first lens L1 of FIG. 6, FIG. 10, FIG. 14, FIG. 18, FIG. 22, FIG. 26, and/or FIG. 30) disposed farthest from the image sensor, including a convex sensor-side surface, and having negative refractive power, a second lens (e.g., the second lens L2 of FIG. 6, FIG. 10, FIG. 14, FIG. 18, FIG. 22, FIG. 26, and/or FIG. 30) disposed between the first lens and the image sensor and having positive refractive power, a third lens (e.g., the third lens L3 of FIG. 6, FIG. 10, FIG. 14, FIG. 18, FIG. 22, FIG. 26, and/or FIG. 30) disposed between the second lens and the image sensor and having positive refractive power, a fourth lens (e.g., the fourth lens LA of FIG. 6, FIG. 10, FIG. 14, FIG. 18, FIG. 22, FIG. 26, and/or FIG. 30) disposed between the third lens and the image sensor and having positive refractive power or negative refractive power, a fifth lens (e.g., the fifth lens L5 of FIG. 6, FIG. 10, FIG. 14, FIG. 18, FIG. 22, FIG. 26, and/or FIG. 30) disposed between the fourth lens and the image sensor and having negative refractive power, a sixth lens (e.g., the sixth lens L6 of FIG. 6, FIG. 10, FIG. 14, FIG. 18, FIG. 22, FIG. 26, and/or FIG. 30) disposed between the fifth lens and the image sensor, including a concave object-side surface, and having positive refractive power, and a seventh lens (e.g., the seventh lens L7 of FIG. 6, FIG. 10, FIG. 14, FIG. 18, FIG. 22, FIG. 26, and/or FIG. 30) disposed between the sixth lens and the image sensor and having negative refractive power. In an embodiment, the lens assembly may satisfy the following [Conditional Expression 1; f/f6<=1] regarding a focal length ‘f’ of the lens assembly and a focal length ‘f6’ of the sixth lens.

According to an embodiment, the memory may store instructions configured to, when executed by the at least one processor, enable the electronic device to perform a focus adjustment operation by moving at least one of the at least seven lenses in a direction of the optical axis.

According to an embodiment, the memory may store instructions configured to, when executed by the at least one processor, enable the electronic device to perform a hand tremor correction operation by moving at least one of the at least seven lenses in a direction parallel to a plane perpendicular to the optical axis.

According to an embodiment, the lens assembly may satisfy the following [Conditional Expression 2; 25<=vd2<=45] regarding an Abbe number ‘vd2’ of the second lens.

According to an embodiment, the lens assembly may satisfy the following [Conditional Expression 3; −3<=(r1+r2)/(r1−r2)<=−1.05] regarding a radius of curvature ‘r1’ of an object-side surface of the first lens, and a radius of curvature ‘r2’ of the sensor-side surface of the first lens.

According to an embodiment, the fifth lens may include a concave sensor-side surface.

According to an embodiment, a refractive index of at least one of the first lens, the third lens, the fourth lens, or the sixth lens may be 1.53 or more and 1.55 or less.

According to an embodiment, an Abbe number of at least one of the first lens, the third lens, the fourth lens, or the sixth lens may be 50 or more and 60 or less.

According to an embodiment, a refractive index of at least one of the second lens, the fifth lens, or the seventh lens may be 1.56 or more and 1.68 or less.

According to an embodiment, an Abbe number of at least one of the fifth lens or the seventh lens may be 18 or more and 40 or less.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A camera module, comprising:
an image sensor; and
a lens assembly comprising at least seven lenses aligned along an optical axis and configured to guide light from outside the camera module to the image sensor,
wherein the at least seven lenses comprise:
a first lens farthest from the image sensor and comprising a convex surface on a sensor-side surface thereof, the first lens having negative refractive power;
a second lens between the first lens and the image sensor, and having positive refractive power;
a third lens between the second lens and the image sensor, and having positive refractive power;
a fourth lens between the third lens and the image sensor, and having positive refractive power or negative refractive power;
a fifth lens between the fourth lens and the image sensor, and having negative refractive power;
a sixth lens between the fifth lens and the image sensor and comprising a concave surface on an object-side surface thereof, the sixth lens having positive refractive power; and
a seventh lens between the sixth lens and the image sensor, and having negative refractive power, and
wherein the lens assembly satisfies:
$$f / f 6 \leq 1 ,$$
wherein f is a focal length of the lens assembly, and f6 is a focal length of the sixth lens.

2. The camera module of claim 1, wherein the lens assembly further satisfies:
$$25 \leq vd 2 \leq 45 ,$$
wherein vd2 is an Abbe number of the second lens.

3. The camera module of claim 2, wherein the lens assembly further satisfies:
$$- 3 \leq ( r 1 + r 2 ) / ( r 1 - r 2 ) \leq - 1.05 ,$$
wherein r1 is a radius of curvature of an object-side surface of the first lens, and r2 is a radius of curvature of the sensor-side surface of the first lens.

4. The camera module of claim 1, wherein the fifth lens comprises a concave surface on a sensor-side surface thereof.

5. The camera module of claim 1, wherein the third lens comprises a convex surface on an object-side surface thereof.

6. The camera module of claim 1 wherein a refractive index of at least one of the first lens, the third lens, the fourth lens, or the sixth lens is 1.53 or more and 1.55 or less.

7. The camera module of claim 6, wherein an Abbe number of at least one of the first lens, the third lens, the fourth lens, or the sixth lens is 50 or more and 60 or less.

8. The camera module of claim 1, wherein a refractive index of at least one of the second lens, the fifth lens, or the seventh lens is 1.56 or more and 1.68 or less.

9. The camera module of claim 8, wherein an Abbe number of at least one of the fifth lens or the seventh lens is 18 or more and 40 or less.

10. The camera module of claim 1, wherein a refractive index of the first lens, a refractive index of the third lens, a refractive index of the fourth lens, and a refractive index of the sixth lens are 1.53 or more and 1.55 or less,
wherein an Abbe number of the first lens, an Abbe number of the third lens, an Abbe number of the fourth lens, and an Abbe number of the sixth lens are 50 or more and 60 or less,
wherein a refractive index of the second lens, a refractive index of the fifth lens, and a refractive index of the seventh lens are 1.56 or more and 1.68 or less, and
wherein an Abbe number of the fifth lens and an Abbe number of the seventh lens are 18 or more and 40 or less.

11. An electronic device comprising:
a camera module;
at least one processor; and
memory storing instructions which, when executed by the at least one processor, cause the electronic device to obtain an image using the camera module,
wherein the camera module comprises:
an image sensor; and
a lens assembly comprising at least seven lenses aligned along an optical axis and configured to guide light from outside the camera module to the image sensor,
wherein the at least seven lenses comprise:
a first lens farthest from the image sensor and comprising a convex surface on a sensor-side surface thereof, the first lens having negative refractive power;
a second lens between the first lens and the image sensor and having positive refractive power;
a third lens between the second lens and the image sensor, and having positive refractive power;
a fourth lens between the third lens and the image sensor, and having positive refractive power or negative refractive power;
a fifth lens between the fourth lens and the image sensor, and having negative refractive power;
a sixth lens between the fifth lens and the image sensor and comprising a concave surface on an object-side surface thereof, the sixth lens having positive refractive power; and
a seventh lens between the sixth lens and the image sensor, and having negative refractive power, and
wherein the lens assembly satisfies:
$$f / f 6 \leq 1 ,$$
wherein f is a focal length of the lens assembly, and f6 is a focal length of the sixth lens.

12. The electronic device of claim 11, wherein the instructions, when executed by the at least one processor, further cause the electronic device to perform a focus adjustment operation by moving at least one of the at least seven lenses in a direction of the optical axis.

13. The electronic device of claim 12, wherein the instructions, when executed by the at least one processor, further cause the electronic device to perform a hand tremor correction operation by moving at least one of the at least seven lenses in a direction parallel to a plane perpendicular to the optical axis.

14. The electronic device of claim 11, wherein the lens assembly further satisfies:
$$25 \leq vd 2 \leq 45 ,$$
wherein vd2 is an Abbe number of the second lens.

15. The electronic device of claim 14, wherein the lens assembly further satisfies:
$$- 3 \leq ( r 1 + r 2 ) / ( r 1 - r 2 ) \leq - 1.05 ,$$
wherein r1 is a radius of curvature of an object-side surface of the first lens, and r2 is a radius of curvature of the sensor-side surface of the first lens.

16. The electronic device of claim 11, wherein the fifth lens comprises a concave surface on a sensor-side surface thereof.

17. The electronic device of claim 11, wherein a refractive index of at least one of the first lens, the third lens, the fourth lens, or the sixth lens is 1.53 or more and 1.55 or less.

18. The electronic device of claim 17, wherein an Abbe number of at least one of the first lens, the third lens, the fourth lens, or the sixth lens is 50 or more and 60 or less.

19. The electronic device of claim 11, wherein a refractive index of at least one of the second lens, the fifth lens, or the seventh lens is 1.56 or more and 1.68 or less.

20. The electronic device of claim 19, wherein an Abbe number of at least one of the fifth lens or the seventh lens is 18 or more and 40 or less.
